(19) United States
(12) Patent Application Publication
(10) Pub. No.: US 2024/0338256 A1
(43) Pub. Date: Oct. 10, 2024

(54) OFFLOAD SERVER, OFFLOAD CONTROL METHOD, AND OFFLOAD PROGRAM

(71) Applicant: Nippon Telegraph and Telephone Corporation, Tokyo (JP)

(72) Inventor: Yoji YAMATO, Musashino-shi, Tokyo (JP)

(21) Appl. No.: 18/575,901

(22) PCT Filed: Jul. 19, 2021
(86) PCT No.: PCT/JP2021/027047

§ 371 Date: Jan. 2, 2024

(51) Int. Cl. G06F 9/52

(52) U.S. Cl. CPC G06F 9/52

(57) ABSTRACT

An offload server includes a performance measurement unit that compiles an application of a parallel processing pattern, arranges the application in an accelerator verification apparatus, and executes processing of measuring performance achieved when offloading to an accelerator is performed, an evaluation value setting unit that sets an evaluation value including a processing time and power consumption and having a higher value as a processing time is shorter and power consumption is lower on the basis of a processing time and power consumption required at a time of offloading measured by the performance measurement unit, and an execution file creation unit that selects a parallel processing pattern having the highest evaluation value from among a plurality of the parallel processing patterns on the basis of a measurement result of a processing time and power consumption, compiles the parallel processing pattern having the highest evaluation value, and creates an execution file.

### TECHNICAL FIELD

The present invention relates to an offload server, an offload control method, and an offload program for automatically offloading functional processing to an accelerator of a graphics processing unit (GPU), a field programmable gate array (FPGA), or the like.

### BACKGROUND ART

Heterogeneous calculation resources other than a central processing unit (CPU) have been increasingly used. For example, performing image processing in a server in which a GPU (accelerator) is enhanced, and accelerating signal processing in an FPGA (accelerator) have been started. The FPGA is a programmable gate array in which a designer or the like can set a configuration after manufacturing, and is a type of a programmable logic device (PLD). In Amazon Web Services (AWS) (registered trademark), GPU instances and FPGA instances are provided, and the resources can also be used on demand. Microsoft (registered trademark) improves search efficiency using an FPGA.

In an open Internet of things (IoT) environment, creation of a wide variety of applications using a service cooperation technology or the like is expected, and performance enhancement of operation applications can be expected by more advanced hardware being utilized. However, for this purpose, programming and setting according to the hardware to be operated are required. For example, a lot of technical knowledge such as compute unified device architecture (CUDA) and open computing language (OpenCL) is required, and the hurdle is high. OpenCL is an open application programming interface (API) in which any computing resources (not limited to a CPU and a GPU) can be handled in a unified manner without being bound by specific hardware.

The following is required in order to enable easy use of a GPU and an FPGA by an application of the user. That is, in a case where a general purpose application such as image processing and cipher processing to be operated is deployed in an OpenIoT environment, an OpenIoT platform desirably analyzes application logic and automatically offloads processing to the GPU and the FPGA.

Development environment CUDA for general purpose GPU (GPGPU) in which computational power of the GPU is also used for purposes other than image processing has been developed. CUDA is a development environment for GPGPU. Furthermore, OpenCL has also appeared as a standard specification for integrally handling heterogeneous hardware such as a GPU, an FPGA, and a many-core CPU.

In CUDA and OpenCL, programming by extension of C language is performed. However, memory copy between a device such as a GPU and a CPU, release, and the like need to be described, and the difficulty of description is high. In actuality, there are not many engineers who can use CUDA or OpenCL.

In order to easily perform GPGPU, there is a technology in which a portion to be subject to parallel processing such as a loop sentence is designated on a directive basis, and a compiler performs conversion into a code for a device according to the directive. There are OpenACC (Open Accelerator) and the like as technical specifications, and a PGI compiler (registered trademark) and the like as compilers. For example, in an example using OpenACC, the user performs designation such that parallel processing or the like is executed using an OpenACC directive on a code written in C/C++/Fortran language. The PGI compiler checks parallelism possibility of a code, generates execution binaries for a GPU and a CPU, and performs execution modularization. IBM JDK (registered trademark) supports a function of offloading parallel processing designation according to a Java (registered trademark) lambda format to the GPU. By using these techniques, the programmer does not need to be aware of data allocation or the like to a GPU memory.

As described above, offload processing to a GPU and an FPGA can be performed by technologies of OpenCL, CUDA, and OpenACC.

However, even if offload processing itself can be performed, there are many issues in appropriate offloading. For example, there is a compiler including an automatic parallelization function such as an Intel compiler (registered trademark). In a case where automatic parallelization is performed, a parallel processing part such as a for sentence (repeated sentence) on a program is extracted. However, in a case where a GPU is used for parallel operation, performance is often not achieved due to an overhead of data exchange between CPU-GPU memories. In a case where the speed is increased using a GPU, a skill holder needs to perform tuning using OpenCL or CUDA and search for an appropriate parallel processing part by a PGI compiler or the like.

For this reason, it is difficult for a user having no skill to improve performance of an application using a GPU, and even in a case where an automatic parallelization technology is used, it takes a lot of time to start use due to trial and error tuning to determine whether to parallelize a for sentence and the like.

Non Patent Literature 1 and 2 exemplifies approaches for automating trial and error of a parallel processing portion.

Non Patent Literature 1 and 2 proposes environment adaptive software for the purpose of causing an application to operate with high performance and low power by automatically performing conversion, resource setting, and the like using a code described once to enable a GPU, an FPGA, a many-core CPU or the like that is present in an environment of an arrangement destination. Furthermore, Non Patent Literature 1 and 2 proposes a scheme of automatically offloading a loop sentence of an application code to a GPU as an element of environment adaptive software, and evaluates performance improvement.

Non Patent Literature 3 proposes a scheme of automatically offloading a loop sentence of an application code to an FPGA as an element of environment adaptive software, and evaluates performance improvement.

Non Patent Literature 4 proposes a scheme of automatically offloading a loop sentence of an application code to a mixed environment of a GPU and an FPGA as an element of environment adaptive software, and evaluates performance improvement.

### CITATION LIST

### Non Patent Literature

Non Patent Literature 1: Y. Yamato, T. Demizu, H. Noguchi and M. Kataoka, “Automatic GPU Offloading Technology for Open IoT Environment,” IEEE Internet of Things Journal, DOI: 10.1109/JIOT.2018.2872545, September 2018 (Electronic Publishing). Vol. 6, Issue 2, pp. 2369-2378 April 2019. (Print Publishing)
Non Patent Literature 2: Y. Yamato, “Study of parallel processing area extraction and data transfer number reduction for automatic GPU offloading of IoT applications,” Journal of Intelligent Information Systems, Springer, DOI: 10.1007/s10844-019-00575-8, August 2019. (Electronic Publishing) Vol. 54, No. 3, pp. 567-584, May 2020. (Print Publishing)
Non Patent Literature 3: Y. Yamato, “Automatic Offloading Method of Loop Statements of Software to FPGA,” International Journal of Parallel, Emergent and Distributed Systems, Taylor & Francis, DOI: 10.1080/17445760.2021.1916020, April 2021.
Non Patent Literature 4: Y. Yamato, “Proposal of Automatic Offloading Method in Mixed Offloading Destination Environment,” 2020 Eighth International Symposium on Computing and Networking Workshops (CANDAR 2020), pp. 460-464, November 2020.

### SUMMARY OF INVENTION

### Technical Problem

Non Patent Literature 1 and 2 proposes a method using evolution calculation in order to automate a parallel processing portion search in a case of offloading processing to a GPU or the like, but only reduction in processing time is evaluated, and reduction in power consumption is not evaluated. Furthermore, reduction in power consumption is not evaluated for automatic offloading to an FPGA in Non Patent Literature 3 and offloading to a mixed environment in Non Patent Literature 4.

That is, in Non Patent Literature 1 to 4, only reduction in processing time at the time of automatic offloading is evaluated, and power consumption is not evaluated. Therefore, there is an issue that performance and power consumption at a migration destination are not necessarily appropriate.

The present invention has been made in view of such a point, and an object of the present invention is to improve performance and reduce power consumption in a case of automatically offloading to an offload device such as a GPU or an FPGA.

### Solution to Problem

In order to solve the above issue, there is provided an offload server that offloads application specific processing to a GPU, the offload server including an application code analysis unit that analyzes a source code of an application, a data transfer designation unit that, on the basis of a result of code analysis, performs designation such that data is transferred by batch before a start and after an end of GPU processing for a variable in which CPU processing and the GPU processing are not mutually referred to or updated and only a result of the GPU processing is returned to a CPU among variables that need transfer between the CPU and the GPU, a parallel processing designation unit that specifies a loop sentence of the application, designates a parallel processing designation sentence in the GPU for each of the specified loop sentence, and performs compiling, a parallel processing pattern creation unit that excludes a loop sentence which causes a compile error from an offloading target and creates a parallel processing pattern of designating whether to execute parallel processing for a loop sentence which does not cause a compile error, a performance measurement unit that compiles the application of the parallel processing pattern, arranges the application in an accelerator verification apparatus, and executes processing of measuring performance achieved when offloading to the GPU is performed, an evaluation value setting unit that sets an evaluation value including a processing time and power consumption and having a higher value as a processing time is shorter and power consumption is lower on the basis of a processing time and power consumption required at a time of offloading measured by the performance measurement unit, and an execution file creation unit that selects a parallel processing pattern having the highest evaluation value from among a plurality of the parallel processing patterns on the basis of a measurement result of the processing time and the power consumption, compiles the parallel processing pattern having the highest evaluation value, and creates an execution file.

### Advantageous Effects of Invention

According to the present invention, performance can be improved and power consumption can be reduced in a case of automatically offloading to an offload device such as a GPU or an FPGA.

### BRIEF DESCRIPTION OF DRAWINGS

FIG. 1 is a functional block diagram illustrating a configuration example of an offload server according to a first embodiment of the present invention.

FIG. 2 is a diagram illustrating automatic offload processing using a GA of the offload server according to the first embodiment described above.

FIG. 3 is a diagram illustrating a search image of a control unit (automatic offload functional unit) based on Simple GA of the offload server according to the first embodiment described above.

FIG. 4 is a diagram illustrating an example of a normal CPU program of a comparative example.

FIG. 5 is a diagram illustrating an example of loop sentences in a case where data is transferred from a CPU to a GPU using a simple CPU program of a comparative example.

FIG. 6 is a diagram illustrating an example of loop sentences in a case where data is transferred from a CPU to a GPU in a case where nesting integration of the offload server according to the first embodiment described above is performed.

FIG. 7 is a diagram illustrating an example of loop sentences in a case where data is transferred from a CPU to a GPU in a case where transfer integration of the offload server according to the first embodiment described above is performed.

FIG. 8 is a diagram illustrating an example of loop sentences in a case where data is transferred from a CPU to a GPU in a case where transfer integration of the offload server according to the first embodiment described above is performed and a temporary area is used.

FIG. 9A is a flowchart for describing an operation outline of implementation of the offload server according to the first embodiment described above.

FIG. 9B is a flowchart for describing the operation outline of the implementation of the offload server according to the first embodiment described above.

FIG. 10 is a diagram illustrating power consumption Watt and a processing time in a case where the Himeno benchmark is offloaded to a GPU of the offload server according to the first embodiment described above.

FIG. 11 is a functional block diagram illustrating a configuration example of an offload server according to a second embodiment of the present invention.

FIG. 12 is a flowchart for describing an operation outline of implementation of the offload server according to the second embodiment described above.

FIG. 13 is a flowchart illustrating performance and power consumption measurement processing of a performance measurement unit of the offload server according to the second embodiment described above.

FIG. 14 is a diagram for describing the operation outline of the implementation of the offload server according to the second embodiment described above.

FIG. 15 is a diagram illustrating a flow of a search for an OpenCL final solution from a C code of the offload server according to the second embodiment described above.

FIG. 16 is a diagram illustrating power consumption Watt and a processing time in a case where MRI-Q is offloaded to an FPGA of the offload server according to the second embodiment described above.

FIG. 17 is a hardware configuration diagram illustrating an example of a computer that implements functions of an offload server according to each embodiment of the present invention.

### DESCRIPTION OF EMBODIMENTS

Hereinafter, an offload server according to a mode for carrying out the present invention (hereinafter, referred to as the “present embodiment”) will be described with reference to the drawings.

### (Description of Principle)

It is currently difficult for a compiler to find compatibility indicating that this loop sentence is suitable for parallel processing of a GPU. How much performance and power consumption are to be achieved by offloading to the GPU is difficult to be predicted unless actual measurement is performed. Therefore, a direction to offload this loop sentence to the GPU is manually performed, and trial and error of measurement is performed.

The present invention automatically finds an appropriate loop sentence to be offloaded to a GPU using a genetic algorithm (GA) that is an evolution calculation method. That is, for a parallelizable loop sentence group, gene conversion is performed with an execution time of a GPU set to 1 and an execution time of a CPU set to 0, and repeated measurement is performed in a verification environment, thereby an appropriate pattern is searched for.

Here, a pattern that can be processed in a short time by measurement is defined as a gene having high fitness. At this time, processing is newly added in which power consumption is also measured and a low-power pattern is also set to have high fitness. For example, as in (processing time)^{-1/2}*(power consumption)^{-1/2}, the fitness of a gene pattern is set to be higher as the processing time is shorter and the power consumption is lower.

Regarding GPU offloading of a loop sentence, automatic speed-up and power reduction are performed by an evolution calculation method described in detail in a first embodiment of including power consumption in fitness and reduction of CPU-GPU transfer.

### First Embodiment

Next, an offload server 1 and the like according to embodiments for carrying out the present invention (hereinafter, referred to as “present embodiments”) will be described.

### [GPU Automatic Offloading of Loop Sentence]

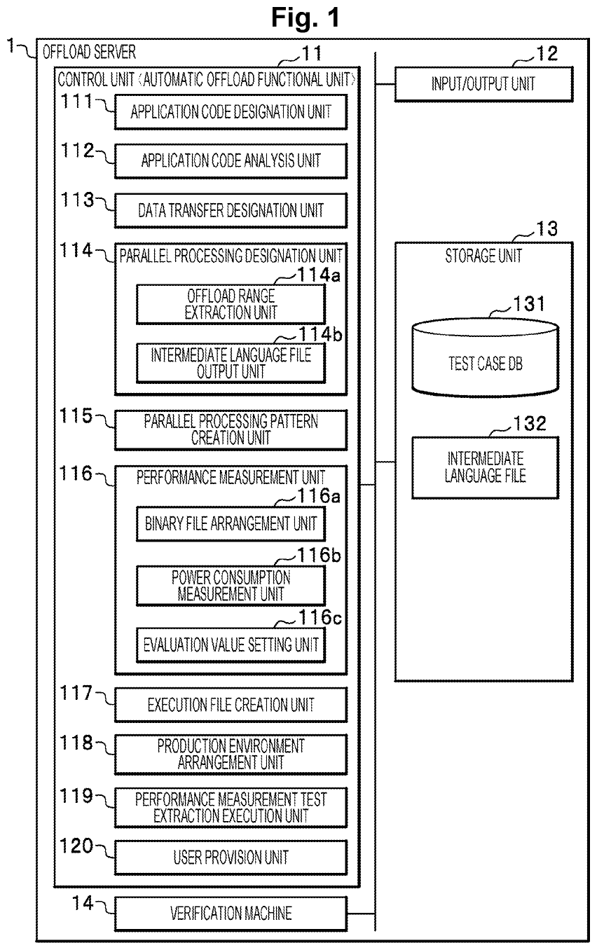

FIG. 1 is a functional block diagram illustrating a configuration example of the offload server 1 according to the first embodiment of the present invention. The present embodiment is an example applied to GPU automatic offloading of a loop sentence.

The offload server 1 is an apparatus that automatically offloads specific processing of an application to an accelerator.

As illustrated in FIG. 1, the offload server 1 includes a control unit 11, an input/output unit 12, a storage unit 13, and a verification machine 14 (accelerator verification apparatus).

The input/output unit 12 includes a communication interface for transmitting and receiving information to and from each machine or the like, input devices including a touch panel, a keyboard, and the like, and an input/output interface for transmitting and receiving information to and from an output device such as a monitor.

The storage unit 13 includes a hard disk, a flash memory, a random access memory (RAM), or the like.

The storage unit 13 stores a test case database (DB) 131, and temporarily stores a program (offload program) for causing each function of the control unit 11 to be executed and information necessary for processing of the control unit 11 (for example, intermediate language file (intermediate file) 132).

The test case DB 131 stores performance test items. The test case DB 131 stores information for performing a test for measuring performance of an application, the speed of which is to be increased. For a deep learning application for image analysis processing, for example, the information is a sample image and test items for executing it.

The verification machine 14 includes a central processing unit (CPU), a GPU, and an FPGA (accelerator) as a verification environment for environment adaptive software.

The control unit 11 is an automatic offload functional unit (automatic offloading function) that is in charge of overall control of the offload server 1. The control unit 11 is implemented by a CPU, which is not illustrated, developing and executing a program (offload program) stored in the storage unit 13 in the RAM, for example.

The control unit 11 includes an application code designation unit (specify application code) 111, an application code analysis unit (analyze application code) 112, a data transfer designation unit 113, a parallel processing designation unit 114, a parallel processing pattern creation unit 115, a performance measurement unit 116, an execution file creation unit 117, a production environment arrangement unit (deploy final binary files to production environment) 118, a performance measurement test extraction execution unit (extract performance test cases and run automatically) 119, and a user provision unit (provide price and performance to a user to judge) 120.

### <Application Code Designation Unit 111>

The application code designation unit 111 designates an input application code. Specifically, the application code designation unit 111 specifies a processing function (image analysis or the like) of a service provided to the user.

### <Application Code Analysis Unit 112>

The application code analysis unit 112 analyzes a source code of the processing function and recognizes structures of loop sentences and use of a specific library such as an FFT library call.

### <Data Transfer Designation Unit 113>

On the basis of a result of code analysis, the data transfer designation unit 113 performs designation such that data is transferred by batch before the start and after the end of GPU processing for a variable in which CPU processing and the GPU processing are not mutually referred to or updated and only a result of the GPU processing is returned to a CPU among variables that need transfer between the CPU and a GPU.

Here, the variables that need transfer between the CPU and the GPU are variables defined by a plurality of files or a plurality of loops from a result of code analysis.

Here, a case of the GPU will be described as an example. In a case of the GPU, designation is performed by the OpenACC grammar, and in a case of an FPGA, designation is performed by the OpenCL grammar. The data transfer designation unit 113 performs designation such that data is transferred by batch before the start and after the end of GPU processing using data copy of OpenACC.

In a case where a variable to be processed by the GPU has already been transferred by batch to the GPU side, the data transfer designation unit 113 adds a directive indicating that transfer is unnecessary.

The data transfer designation unit 113 explicitly indicates that transfer is unnecessary using data present of OpenACC for a variable that is transferred by batch before the start of the GPU processing and does not need to be transferred at a timing of loop sentence processing.

At the time of data transfer between the CPU and the GPU, the data transfer designation unit 113 creates a temporary area on the GPU side (#pragma acc declare create), stores data in the temporary area, and then synchronizes the temporary area (#pragma acc update), thereby directing variable transfer.

On the basis of a result of code analysis, the data transfer designation unit 113 designates GPU processing to a loop sentence using at least one selected from the group consisting of a kernels directive, a parallel loop directive, and a parallel loop vector directive of OpenACC.

The kernels directive of OpenACC is used for a single loop and a tightly nested loop.

The parallel loop directive of OpenACC is used for a non-tightly nested loop.

The parallel loop vector directive of OpenACC is used for a loop that cannot be parallelized but can be vectorized.

### <Parallel Processing Designation Unit 114>

The parallel processing designation unit 114 specifies loop sentences (repeated sentences) of an application, designates processing in the GPU by a directive of OpenACC for each of the repeated sentences, and performs compiling.

The parallel processing designation unit 114 includes an offload range extraction unit (extract offloadable area) 114a and an intermediate language file output unit (output intermediate file) 114b.

The offload range extraction unit 114a specifies processing that can be GPU-offloaded such as a loop sentence and extracts an intermediate language in accordance with the offload processing. Here, the Intermediate language is an OpenACC language file (C language extension file in which processing is specified by the OpenACC grammar) in a case of the GPU, and is an OpenCL language file (C language extension file in which processing is specified by the OpenCL grammar) in a case of the FPGA.

The intermediate language file output unit 114b outputs the extracted intermediate language file 132. The extraction of the intermediate language is not ended when it is performed once and is repeated to try and optimize execution to search for an appropriate offload region.

### <Parallel Processing Pattern Creation Unit 115>

The parallel processing pattern creation unit 115 excludes a loop sentence which causes a compile error from an offloading target and creates parallel processing patterns of designating whether to execute parallel processing on a repeated sentence which does not cause a compile error.

### <Performance Measurement Unit 116>

The performance measurement unit 116 compiles an application of a parallel processing pattern, arranges the compiled application in the verification machine 14, and executes processing of measuring performance achieved when offloading to the GPU is performed.

The performance measurement unit 116 includes a binary file arrangement unit (deploy binary files) 116a, a power consumption measurement unit 116b (performance measurement unit), and an evaluation value setting unit 116c. Note that the evaluation value setting unit 116c is included in the performance measurement unit 116, but may be another independent functional unit.

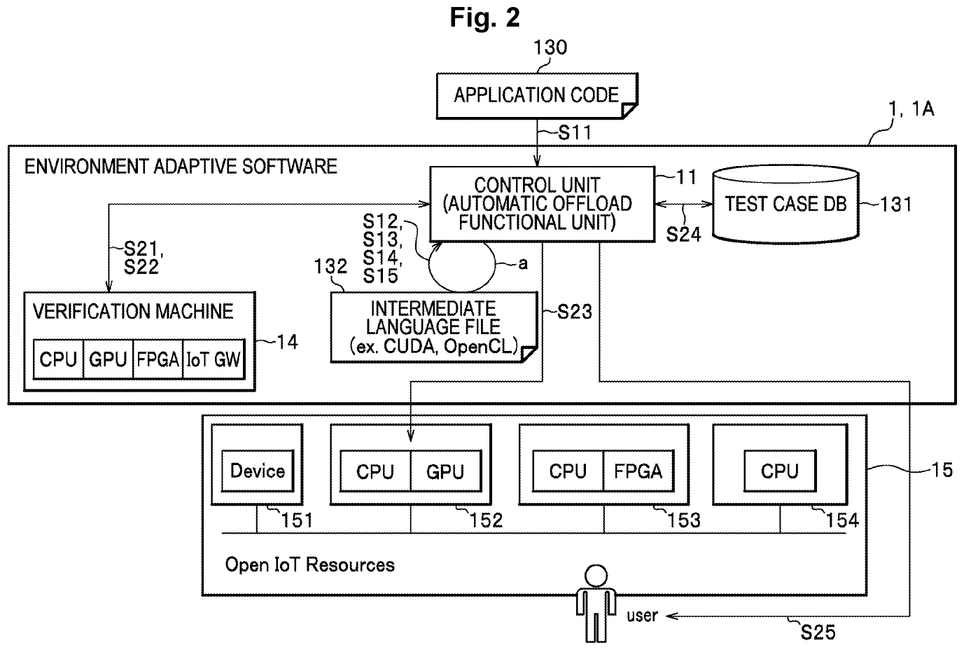

The performance measurement unit 116 executes an arranged binary file, measures performance achieved when the offloading is performed, and returns the result of the performance measurement to the offload range extraction unit 114a. In this case, the offload range extraction unit 114a extracts another parallel processing pattern, and the intermediate language file output unit 114b tries the performance measurement on the basis of the extracted intermediate language (see the reference sign a in FIG. 2, which will be described below).

The binary file arrangement unit 116a deploys (arranges) an execution file derived from the intermediate language in the verification machine 14 including a GPU.

The power consumption measurement unit 116b measures a processing time and power consumption required at the time of offloading. Regarding the power consumption, in a GPU-equipped machine, the GPU power can be measured by an nvidia-smi command or the like of an NVIDIA (registered trademark) tool, and the CPU power can be measured by an s-tui command or the like. In an FPGA-equipped server, the entire server power can be measured by an ipmitool command of an intelligent platform management interface (IPMI).

The evaluation value setting unit 116c sets an evaluation value including a processing time and power consumption and having a higher value as a processing time is shorter and power consumption is lower on the basis of a processing time and power consumption required at the time of offloading measured by the performance measurement unit 116 and the power consumption measurement unit 116b. The evaluation value is set to, for example, (processing time)^{-1/2}*(power consumption)^{-1/2}. The shorter the processing time and the lower the power consumption, the higher the evaluation value and the higher the fitness.

Furthermore, in a case where evaluation to be emphasized is different between high performance and low power consumption, one of (processing time)^{-1/2} and (power consumption)^{-1/2} may be weighted.

### <Execution File Creation Unit 117>

The execution file creation unit 117 selects a parallel processing pattern having the highest evaluation value from among a plurality of the parallel processing patterns on the basis of the result of repeating the measurement of a processing time and power consumption a predetermined number of times, compiles the parallel processing pattern having the highest evaluation value, and creates an execution file.

### <Production Environment Arrangement Unit 118>

The production environment arrangement unit 118 arranges the created execution file in a production environment for the user (“arrange it in final binary file production environment”) The production environment arrangement unit 118 determines a pattern that designates a final offload region and deploys it in the production environment for the user.

### <Performance Measurement Test Extraction Execution Unit 119>

After the execution file is arranged, the performance measurement test extraction execution unit 119 extracts performance test items from the test case DB 131 and executes a performance test (“arrange final binary file in production environment”).

After the execution file is arranged, the performance measurement test extraction execution unit 119 extracts the performance test items from the test case DB 131 and automatically executes the extracted performance test to show the performance to the user.

### <User Provision Unit 120>

The user provision unit 120 presents information regarding a price, performance, and the like based on the result of the performance test to the user (“provide information regarding price, performance, and the like to user”) The test case DB 131 stores data for automatically performing a test for measuring performance of an application. The user provision unit 120 presents, to the user, a result of executing the test data in the test case DB 131 and a price of the entire system determined from each unit price of a resource (virtual machine, FPGA instance, GPU instance, and the like) used in the system. The user determines whether to start charged utilization of the service on the basis of the presented information regarding a price, performance, and the like.

### [Application of Genetic Algorithm]

The offload server 1 can use an evolution calculation method such as the GA for optimization of offloading. A configuration of the offload server 1 in a case where the GA is used is as follows.

In other words, the parallel processing designation unit 114 defines the number of loop sentences (repeated sentences) which do not cause a compile error as a gene length on the basis of the genetic algorithm. The parallel processing pattern creation unit 115 defines a case where accelerator processing is performed as any one of 1 or 0 and defines a case where the accelerator processing is not performed as the other one of 0 or 1 and maps whether the accelerator processing can be performed in a gene pattern.

The parallel processing pattern creation unit 115 prepares gene patterns of a designated number of individuals in which each value of genes is randomly created as 1 or 0, and the performance measurement unit 116 compiles an application code that designates a parallel processing designation sentence in the GPU according to each of the individuals, and arranges the application code in the verification machine 14. The performance measurement unit 116 executes processing for performance measurement in the verification machine 14.

Here, in a case where a gene having the same parallel processing pattern as a previous one occurs in a middle generation, the performance measurement unit 116 uses, as a performance measurement value, the same value without performing the compiling of the application code corresponding to the parallel processing pattern and the performance measurement.

Also, the performance measurement unit 116 sets the performance measurement value to a predetermined time (long time) as handling at the time of timeout for an application code which causes a compile error and an application code for which the performance measurement does not end in a predetermined time.

The execution file creation unit 117 performs performance measurement on all the individuals and evaluates individuals having shorter processing times as having higher fitness. The execution file creation unit 117 selects, as individuals having high performance, individuals having higher fitness from among all the individuals, performs crossover and mutation processing on the selected individuals, and creates next generation individuals. As the above selection, there is a method such as roulette selection of stochastically performing selection according to a ratio of fitness. The execution file creation unit 117 selects the parallel processing pattern having the highest performance as a solution after the processing is ended a number of times corresponding to a designated number of generations.

Hereinafter, automatic offloading operation of the offload server 1 configured as described above will be described.

### [Automatic Offloading Operation]

The offload server 1 of the present embodiment is an example applied to GPU automatic offloading of user application logic as an elemental technology of environment adaptive software.

FIG. 2 is a diagram illustrating automatic offload processing using the GA of the offload server 1.

As illustrated in FIG. 2, the offload server 1 is applied to an elemental technology for environment adaptive software. The offload server 1 includes the control unit (automatic offload functional unit) 11, the test case DB 131, the intermediate language file 132, and the verification machine 14.

The offload server 1 acquires an application code 130 that the user uses.

The offload server 1 automatically offloads functional processing to accelerators of an apparatus 152 including a CPU and a GPU and an apparatus 153 including a CPU and an FPGA.

Hereinafter, operations of each component will be described with reference to step numbers in FIG. 2.

### <Step S11: Specify Application Code>

In step S11, the application code designation unit 111 (see FIG. 1) specifies a processing function (image analysis or the like) of a service provided to the user. Specifically, the application code designation unit 111 designates an input application code.

### <Step S12: Analyze Application Code>

In step S12, the application code analysis unit 112 (see FIG. 1) analyzes a source code of a processing function and recognizes structures of loop sentences and use of specific library such as an FFT library call.

### <Step S13: Extract Offloadable Area>

In step S13, the parallel processing designation unit 114 (see FIG. 1) specifies loop sentences (repeated sentences) of the application, designates GPU processing by OpenACC for each of the repeated sentences, and performs compiling. Specifically, the offload range extraction unit 114a (see FIG. 1) specifies processing that can be offloaded to the GPU such as loop sentences, and extracts an intermediate language in accordance with the offload processing.

### <Step S14: Output Intermediate File>

In step S14, the intermediate language file output unit 114b (see FIG. 1) outputs the intermediate language file 132. The extraction of the intermediate language is not ended when it is performed once and is repeated to try and optimize execution to search for an appropriate offload region.

### <Step S15: Compile Error>

In step S15, the parallel processing pattern creation unit 115 (see FIG. 1) excludes loop sentences which cause a compile error from offloading targets and creates parallel processing patterns of designating whether to execute parallel processing on repeated sentences which do not cause a compile error.

### <Step S21: Deploy Binary Files>

In step S21, the binary file arrangement unit 116a (see FIG. 1) deploys an execution file derived from the intermediate language in the verification machine 14 including a GPU. The binary file arrangement unit 116a starts the arranged file, executes an assumed test case, and measures performance achieved when offloading is performed.

### <Step S22: Measure Performances>

In step S22, the performance measurement unit 116 (see FIG. 1) executes the arranged file and measures performance and power consumption achieved when offloading is performed.

In order to obtain a further appropriate offload region, the result of the performance measurement is returned to the offload range extraction unit 114a, and the offload range extraction unit 114a extracts another pattern. Then, the intermediate language file output unit 114b tries performance measurement on the basis of the extracted intermediate language (see the reference sign a in FIG. 2). The performance measurement unit 116 repeats performance measurement in the verification environment and finally determines a code pattern to be deployed.

As indicated by the reference sign a in FIG. 2, the control unit 11 compiles each of the repeated sentences by designating GPU processing by OpenACC.

### <Step S23: Deploy Final Binary Files to Production Environment>

In step S23, the production environment arrangement unit 118 determines a pattern that designates a final offload region and deploys the pattern in the production environment for the user.

### <Step S24: Extract Performance Test Cases and Run Automatically>

In step S24, the performance measurement test extraction execution unit 119 extracts the performance test items from the test case DB 131 after the execution file is arranged, and automatically executes the extracted performance test to show the performance to the user.

### <Step S25: Provide Price and Performance to a User to Judge>

In step S25, the user provision unit 120 presents information regarding a price, performance, and the like based on the result of the performance test to the user. The user determines whether to start charged utilization of the service on the basis of the presented information regarding a price, performance, and the like.

Above steps S11 to S25 are performed in the background of the user's service utilization, and they are assumed to be performed on the first day of temporary utilization, for example.

As described above, in a case of an application to an elemental technology of environment adaptive software, the control unit (automatic offload functional unit) 11 of the offload server 1 extracts an offload region from the source code of the application that the user uses to offload the functional processing and outputs the intermediate language (steps S11 to S15). The control unit 11 arranges and executes, in the verification machine 14, the execution file derived from the intermediate language and verifies effects of the offloading (steps S21 and S22). After the verification is repeated, and an appropriate offload region is determined, the control unit 11 deploys the execution file in the production environment that is actually provided to the user and provides it as a service (steps S23 to S25).

Note that, in the above description, a processing flow for performing code conversion, resource amount adjustment, and arrangement place adjustment necessary for environment adaptation by batch has been described, but the present invention is not limited thereto, and only processing that is desirably performed can be cut out. For example, in a case where only code conversion for the GPU is desirably performed, only necessary portions of the environment adaptation function, the verification environment, and the like in steps S11 to S21 described above may be used.

### [GPU Automatic Offloading Using Genetic Algorithm (GA)]

The GPU automatic offloading is processing of repeating steps S12 to S22 in FIG. 2 on the GPU and obtaining an offload code to be finally deployed in step S23.

The GPU is a device that typically does not secure latency but is suitable for enhancing a throughput through parallel processing. There are a wide variety of applications operated in IoT. Encryption processing of IoT data, image processing for camera video analysis, machine learning processing for analyzing a large amount of sensor data, and the like are representative processing, and these include a large amount of repeated processing. Thus, repeated sentences in the application are automatically offloaded to the GPU to achieve an increase in speed.

However, appropriate parallel processing is needed to increase the speed as described above as the related art. In a case where a GPU is used, in particular, performance is often not achieved if the data size and the number of loops due to memory transfer between the CPU and the GPU are not large. Also, there may be a case where a combination of individual loop sentences (repeated sentences) for which the speed can be increased in parallel does not lead to the highest speed due to a timing of memory data transfer or the like. In a case where the speeds for three sentences, namely, the first, fifth, and tenth sentences from among ten for sentences (repeated sentences) can be increased as compared with the CPU, for example, the combination of the three sentences, namely, the first, fifth, and tenth sentences does not lead to the highest speed.

There is an attempt to perform trial and error to ascertain whether for sentences can be processed in parallel and optimization is performed using a PGI compiler in order to appropriately designate a parallel region. However, there is an issue that a large amount of operations is needed for the trial and error, user's utilization is delayed when the service is provided, and this may lead to an increase in cost.

Thus, an appropriate offload region is automatically extracted from a general-purpose program that is not assumed to be parallelized in the present embodiment. To do so, checking of parallelizable for sentences first and then repeating performance verification trial on the parallelizable for sentence group in a verification environment using the GA to search for an appropriate region are implemented. Patterns, the speeds of which can be increased, are efficiently searched for from an enormous number of possible parallel processing patterns by the parallel processing patterns, the speeds of which can be increased, being held and recombined in the form of a part of a gene after possibilities are narrowed down to the parallelizable for sentences.

### [Search Image of Control Unit (Automatic Offload Functional Unit) 11 Based on Simple GA]

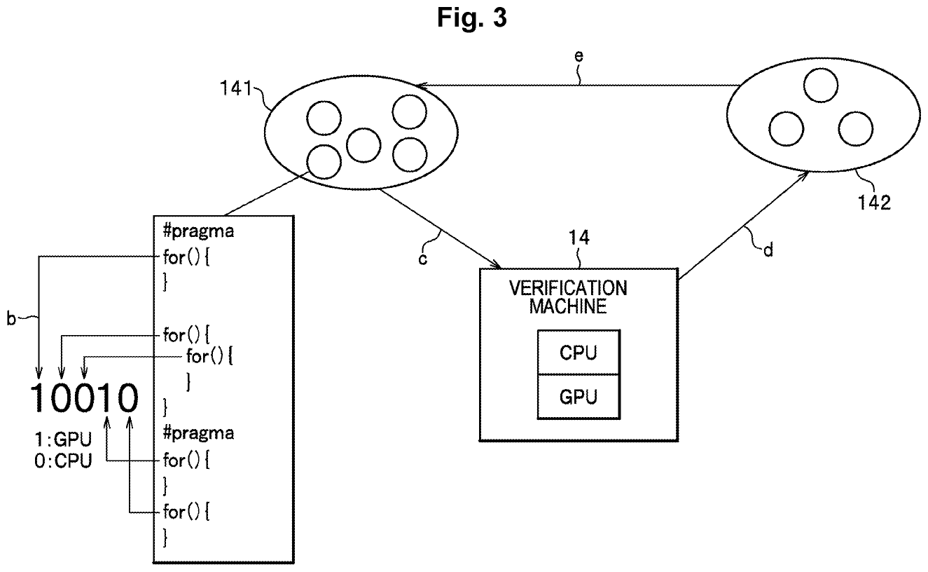

FIG. 3 is a diagram illustrating a search image of the control unit (automatic offload functional unit) 11 based on a Simple GA. FIG. 3 illustrates a search image of processing and gene sequence mapping of for sentences.

The GA is one combinational optimization method that simulates a biological evolution process. The GA flowchart includes initialization-evaluation-selection-crossover-mutation-end determination.

In the present embodiment, the Simple GA of simplified processing is used from among GAs. The Simple GA is a simplified GA in which genes are only 1 and 0 and a gene value at one location is reversed for a roulette selection, one-point crossover, and mutation.

### <Initialization>

In initialization, whether all the for sentences of the application code can be processed in parallel, and parallelizable for sentences are mapped in a gene sequence. A case where GPU processing is performed is represented as 1, and a case where GPU processing is not performed is represented as 0. A designated number M of genes are prepared, and allocation of 1 or 0 is randomly performed on one for sentence.

Specifically, the control unit (automatic offload functional unit) 11 (see FIG. 1) acquires the application code 130 (see FIG. 2) that the user uses and checks whether the for sentences can be processed in parallel from code patterns 141 of the application code 130 as illustrated in FIG. 3. In a case where five for sentences are found from the code patterns 141 (see the reference sign b in FIG. 3) as illustrated in FIG. 3, one digit is allocated to each of the for sentences, and in this case, five digits of 1 or 0 are randomly allocated to the five for sentences. For example, a case of CPU processing is represented as 0, and a case of passing it to the GPU is represented as 1. However, 1 or 0 is randomly allocated in this stage.

The code corresponding to the gene length includes five digits, and the number of codes with the five-digit gene length is 25=32 patterns including 10001, 10010, . . . , for example. Note that in FIG. 3, the circles in the code patterns 141 are illustrated as images of codes.

### <Evaluation>

In evaluation, deployment (arrangement) and performance measurement (deploy & performance measurement) are performed (see the reference sign c in FIG. 3). In other words, the performance measurement unit 116 (see FIG. 1) compiles codes corresponding to genes, deploys them in the verification machine 14, and executes them. The performance measurement unit 116 performs benchmark performance measurement. Fitness of genes of patterns having satisfactory performance and power consumption (parallel processing patterns) is evaluated as being high.

Here, processing is newly added in which while a pattern that can be processed in a short time in measurement is set as a gene having high fitness, power consumption is also measured, and a pattern having low power is also set to have high fitness. For example, an evaluation value indicated in Formula (1) is introduced, and on the basis of the evaluation value, the fitness of a gene pattern is set to be higher as the processing time is shorter and the power consumption is lower. As an example, in a case where (processing time)^{-1/2} is 0.1 and (power consumption)^{-1/2} is 0.1, the evaluation value is 0.1*0.1=0.01. In a case where another evaluation value is greater than this 0.01, fitness of the higher evaluation value is used.

$$\begin{matrix}[ Math . 1 ] & \\ Evaluation value = \frac{1}{\sqrt{Processing time}} \times \frac{1}{\sqrt{Power consumption}} & ( 1 )\end{matrix}$$

### <Selection>

In selection, high performance and low power code patterns are selected (select high performance code patterns) on the basis of the fitness (see the reference sign d in FIG. 3). The performance measurement unit 116 (see FIG. 1) selects a designated number of genes having high fitness on the basis of the fitness. In the present embodiment, roulette selection in accordance with the fitness and elite selection of the highest fitness gene are performed.

In FIG. 3, a decrease in the number of circles in the selected code patterns (select code patterns) 142 to three is illustrated as a search image.

### <Crossover>

In crossover, some genes are exchanged at a certain point between selected individuals at a specific crossover rate Pc, and child individuals are created.

Genes of a certain pattern (parallel processing pattern) that has been roulette-selected and genes of another pattern are crossed over. One-point crossover is performed at any position, and for example, crossover is performed at the third digit in the above five-digit code.

### <Mutation>

In mutation, each value of the individual genes is changed from 0 to 1 or from 1 to 0 at a specific mutation rate Pm.

Furthermore, mutation is introduced to avoid a local solution. Note that a mode in which mutation is not performed may also be employed in order to save the amount of arithmetic operation.

### <End Determination>

As illustrated in FIG. 3, generation of next generation code patterns after crossover and mutation is performed (generate next generation code patterns after crossover & mutation) (see the reference sign e in FIG. 3).

In end determination, processing is ended after it is repeated the number of times T corresponding to a designated number of generations, and the gene having the highest fitness is defined as a solution.

For example, performance measurement is performed, and the fastest three patterns 10010, 01001, and 00101 are selected. Recombination is performed from these three patterns using the GA for the next generation, and for example, a new pattern (parallel processing pattern) 11011 is created by crossing the first and the second patterns. At this time, mutation of freely changing 0 to 1 is inserted into the recombined pattern. The above processing is repeated, and the fastest pattern is found. A designated generation (twentieth generation, for example) or the like is determined, and a pattern remaining in the final generation is defined as the final solution.

### <Deployment (Arrangement)>

Deployment in the production environment is performed again using the parallel processing pattern having the highest processing performance corresponding to the gene having the highest fitness, and it is provided to the user.

### <Supplementary Description>

A case where a considerable number of for sentences (loop sentences; repeated sentences) that cannot be offloaded to the GPU are present will be described. If there are 200 for sentences, for example, the number of for sentences that can be offloaded to the GPU is about 30. Here, for sentences that cause an error are excluded, and the GA is performed on these 30 for sentences.

For OpenACC, there is a compiler that can perform GPU offloading by extracting a byte code for the GPU through designation by a directive #pragma acc kernels and executing the byte code. By a command of a for sentence being written in this #pragma, whether the for sentence operates on the GPU can be determined.

For example, in a case of using C/C++, the C/C++ code is analyzed and a for sentence is found. In a case where a for sentence is found, writing is performed on the for sentence using #pragma acc kernels, #prama acc parallel loop, or #prama acc parallel loop vector, which are parallel processing grammars in OpenACC. Specifically, each for sentence is put into #pragma acc kernels, #prama acc parallel loop, or #prama acc parallel loop vector and compiled, and if an error occurs, the for sentence cannot be subjected to GPU processing in the first place and thus is excluded.

In this manner, remaining for sentences are found. Then, the for sentences which do not cause an error are regarded as a length (gene length). The gene length is five if the number of for sentences which do not cause an error is five, and the gene length is ten if the number of for sentences which do not cause an error is ten. Note that a case where parallel processing cannot be performed is a case where there is dependency on data, such as a case where previous processing is also used in the next processing.

The above processing is performed in a preparation stage. Next, GA processing is performed.

A code pattern having the gene length corresponding to the number of for sentences is obtained. First, parallel processing patterns 10010, 01001, 00101, . . . are randomly allocated. The GA processing is performed and compiling is performed. At that time, there may be a case where an error occurs even if the for sentence can be offloaded. This is a case where for sentences are hierarchical (this can be processed by the GPU if either one of them is designated). In this case, the for sentences which cause an error may be left. Specifically, there is a method of making such for sentences time out due to their increased processing times.

Deployment in the verification machine 14 is performed, and fitness is evaluated as being higher as the processing time for the benchmark, for example, benchmark with image processing in a case of image processing is shorter. The power of −½ of the processing time is employed, and for example, fitness is evaluated as 1 for the processing time of 1 second, fitness is evaluated as 0.1 for the processing time of 100 seconds, and fitness is evaluated as 10 for the processing time of 0.01 seconds.

Code patterns having high fitness are selected, and for example, three to five code patterns are selected from among 10 code patterns, and a new code pattern is created by recombining them. At this time, there may also be a case where the same code pattern as the previous one may be created in the process of the creation. In this case, since the same benchmark does not need to be performed, the same data as the previous data is used. In the present embodiment, the code patterns and the processing times are saved in the storage unit 13.

The search image of the control unit (automatic offload functional unit) 11 based on the Simple GA has been described hitherto. Next, a batch processing method of data transfer will be described.

### [Batch Processing Method of Data Transfer]

### <Basic Idea>

In order to reduce CPU-GPU transfer, in addition to transferring a variable of a nested loop as high as possible, the present invention makes a batch of a large number of variable transfer timings, and reduces transfer in which the compiler further automatically performs transfer.

In reducing transfer, not only the nesting unit but also variables in which the transfer timings to the GPU can be collected are transferred by batch. For example, if a variable is not a variable, for example, for processing a processing result of the GPU by the CPU and performing processing again by the GPU, variables defined by the CPU used in a plurality of loop sentences can be transmitted by batch to the GPU before GPU processing is started, and returned to the CPU after all the GPU processing is completed.

In order to grasp loops and variable reference relationship at the time of code analysis, regarding variables defined in a plurality of files from the result, designation is performed such that variables in which GPU processing and CPU processing are not nested and division into the CPU processing and the GPU processing can be performed are transferred by batch using a data copy sentence of OpenACC.

Explicit indication is performed that transfer is unnecessary for a variable that is transferred by batch before the start of the GPU processing and does not need to be transferred at a timing of loop sentence processing using data present.

At the time of data transfer between the CPU and the GPU, a temporary area is created (#pragma acc declare create), data is stored in the temporary area, and then the temporary area is synchronized (#pragma acc update), thereby directing transfer.

### COMPARATIVE EXAMPLES

First, comparative examples will be described.

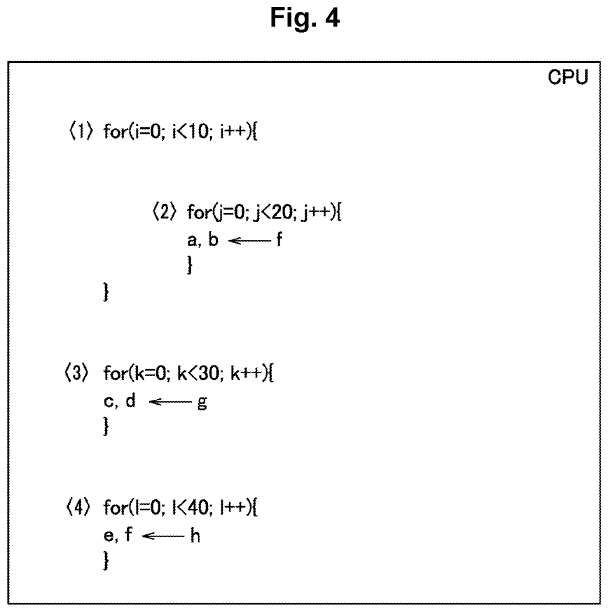

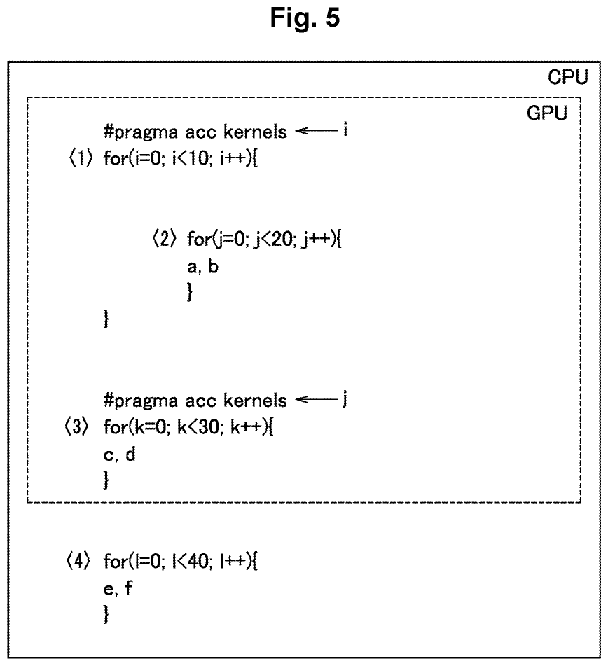

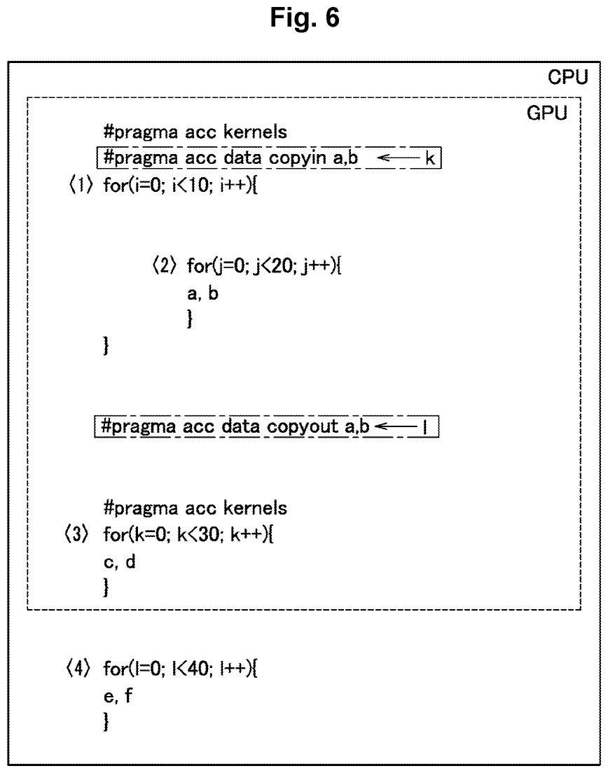

The comparative examples are a normal CPU program (see FIG. 4), simple GPU usage (see FIG. 5), and nesting batch processing (Non Patent Literature 2) (see FIG. 6). Note that the following description, <1> to <4> and the like of the beginning of loop sentences in the drawings are added for convenience of description (the same applies to the other drawings and the description thereof).

Loop sentences of the normal CPU program illustrated in FIG. 4 are described on the CPU program side, and

<1> loop [for(i = 0; i < 10; i++)] {
}
into which
<2> loop [for(j = 0; j < 20; j+)] {

is present. The reference sign f in FIG. 4 is a setting of variables a, b in the <2> loop.

Furthermore,

<3> loop [for(k = 0; k < 30; k++)] {
}
and
<4> loop [for(l = 0; l < 40; l++)] {
}

follow. The reference sign g in FIG. 4 is a setting of variables c, d in the <3> loop, and the reference sign h in FIG. 4 is a setting of variables e, f in the <4> loop.

The normal CPU program illustrated in FIG. 4 is executed by the CPU (not using the GPU).

FIG. 5 is a diagram illustrating loop sentences in a case where data is transferred from the CPU to the GPU using the normal CPU program illustrated in FIG. 4 in simple GPU usage. Types of data transfer include data transfer from the CPU to the GPU and data transfer from the GPU to the CPU. Hereinafter, data transfer from the CPU to the GPU will be taken as an example.

Loop sentences in the simple GPU usage illustrated in FIG. 5 are described on the CPU program side, and

<1> loop [for(i = 0; i < 10; i++)] {
}
into which
<2> loop [for(j = 0; j < 20; j+)] {

is present.

Further, as indicated by the reference sign i in FIG. 5, a parallel processable processing part such as a for sentence by the PGI compiler is designated above <1> loop [for (i=0; i<10; i++)] { } by a directive #pragma acc kernels (parallel processing designation sentence) of OpenACC.

Data is transferred from the CPU to the GPU by #pragma acc kernels, as indicated by a broken-line frame including the reference sign i in FIG. 5. Here, since a, b are transferred at this timing, they are transferred 10 times.

Further, as indicated by the reference sign j in FIG. 5, a parallel processable processing part such as a for sentence by the PGI compiler is designated above <3> loop [for (k=0; k<30; k++)] { } by a directive #pragma acc kernels of OpenACC.

c, d are transferred at this timing by #pragma acc kernels as illustrated in the broken-line frame including the reference sign j in FIG. 5.

Here, #pragma acc kernels is not designated above <4> loop [for (1=0; 1<40; 1++)] { }. GPU processing is not performed on this loop because performing GPU processing is inefficient.

FIG. 6 is a diagram illustrating loop sentences in a case where data is transferred from the CPU to the GPU and from the GPU to the CPU by nesting batch processing (Non Patent Literature 2).

In the loop sentences illustrated in FIG. 6, a data transfer direction row from the CPU to the GPU, here, #pragma acc data copyin (a,b) of a copyin clause of the variables a, b is inserted at a position indicated by the reference sign k in FIG. 6. Note that, in the present specification, parentheses ( ) are added to copyin (a,b) in terms of notation. The same notation method is adopted for copyout (a,b) and datacopyin (a, b, c, d) to be described below.

The above #pragma acc data copyin (a,b) is designated in the uppermost loop that does not include a setting and a definition of the variable a (here, above <1> loop [for (i=0; i<10; i++)] { }).

Since a, b are transferred at a timing indicated by a dot-and-dash line frame including the reference sign k in FIG. 6, transfer occurs once.

Furthermore, in the loop sentences illustrated in FIG. 6, a data transfer direction row from the GPU to the CPU, here, #pragma acc data copyout (a,b) of a copyout clause of the variables a, b is inserted at a position indicated by the reference sign 1 in FIG. 6.

The above #pragma acc data copyout (a,b) is designated under <1> loop [for (i=0; i<10; i++)] { }.

As described above, in data transfer from the CPU to the GPU, the data transfer is explicitly directed by #pragma acc data copyin (a,b) of the copyin clause of the variable a being inserted into the position described above. As a result, data transfer by batch can be performed in the higher loop as much as possible, and inefficient transfer in which data is transferred every time for each loop like the loop sentences in the simple GPU usage illustrated in FIG. 5 can be avoided.

### EMBODIMENT

Next, the present embodiment will be described.

<<Explicit Indication of Variable that does not Need to be Transferred Using Data Present>>

In the present embodiment, regarding variables defined in a plurality of files, designation is performed such that variables in which GPU processing and CPU processing are not nested and division into the CPU processing and the GPU processing can be performed are transferred by batch using a data copy sentence of OpenACC. In addition, explicit indication of a variable that is transferred by batch and does not need to be transferred at the timing is performed using data present.

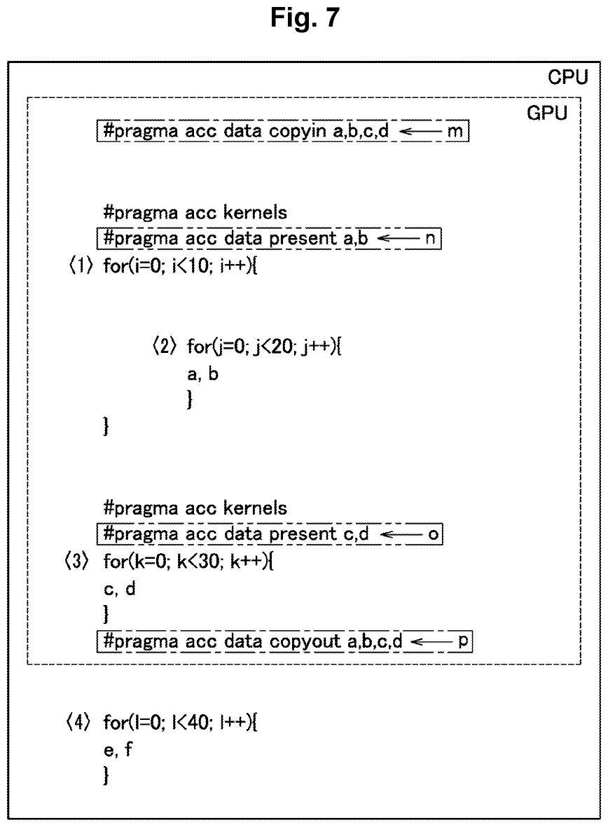

FIG. 7 is a diagram illustrating loop sentences by transfer batch processing at the time of data transfer of the CPU-GPU according to the present embodiment. FIG. 7 corresponds to the nesting batch processing of FIG. 6 of the comparative example.

In the loop sentences illustrated in FIG. 7, a data transfer direction row from the CPU to the GPU, here, #pragma acc datacopyin (a,b,c,d) of a copyin clause of variables a, b, c, d is inserted at a position indicated by the reference sign m in FIG. 7.

The above #pragma acc data copyin (a,b,c,d) is designated in the uppermost loop that does not include a setting and a definition of the variable a (here, above <1> loop [for (i=0; i<10; i++)] { }).

As described above, regarding variables defined in a plurality of files, designation is performed such that variables in which GPU processing and CPU processing are not nested and division into the CPU processing and the GPU processing can be performed are transferred by batch using a data copy sentence #pragma acc data copyin (a,b, c, d) of OpenACC.

Since a, b, c, d are transferred at a timing indicated by a dot-and-dash line frame including the reference sign m in FIG. 7, transfer occurs once.

Then, variables that are transferred by batch using the #pragma acc data copyin (a, b, c, d) and do not need to be transferred at the timing are designated using a data present sentence #pragma acc data present (a,b) that explicitly indicates that the variables are already present in the GPU at the timing indicated by a two-dot chain line including the reference sign n in FIG. 7.

Variables that are transferred by batch using the #pragma acc data copyin (a, b, c, d) and do not need to be transferred at the timing are designated using a data present sentence #pragma acc data present (c,d) that explicitly indicates that the variables are already present in the GPU at the timing indicated by a two-dot chain line including the reference sign o in FIG. 7.

At a timing when GPU processing is performed on loops of <1> and <3> and the GPU processing ends, a data transfer direction row from the GPU to the CPU, here, #pragma acc datacopyout (a, b, c, d) of a copyout clause of the variables a, b, c, d is inserted at the position p at which the <3> loop ends in FIG. 7.

Transfer can be reduced and the efficiency of the offloading means can be further improved by variables that can be transferred by batch by designation of transfer by batch being transferred by batch and variables that are already transferred and do not need to be transferred being explicitly indicated using data present. However, even if transfer is directed by OpenACC, the compiler may automatically determine to perform transfer depending on the compiler. The automatic transfer by the compiler is an event in which automatic transfer is performed depending on the compiler although transfer between the CPU and the GPU is originally unnecessary, against a direction of OpenACC.

### <<Data Temporary Area Storage>>

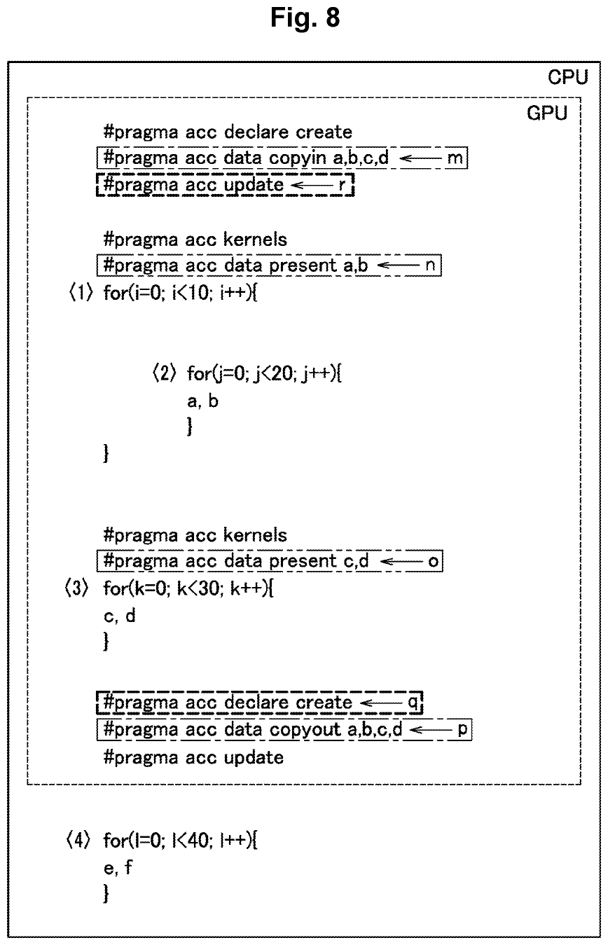

FIG. 8 is a diagram illustrating loop sentences by transfer batch processing at the time of data transfer of the CPU-GPU according to the present embodiment. FIG. 8 corresponds to the nesting batch processing and explicit indication of variables that do not need to be transferred in FIG. 7.

In the loop sentences illustrated in FIG. 8, a declare create sentence #pragma acc declare create of OpenACC for creating a temporary area at the time of data transfer between the CPU and the GPU is designated at the position indicated by the reference sign q in FIG. 8. Accordingly, at the time of data transfer between the CPU and the GPU, a temporary area is created (#pragma acc declare create), and data is stored in the temporary area.

Furthermore, transfer is directed by a declare create sentence #pragma acc update of OpenACC for synchronizing the temporary area being designated at the position indicated by the reference sign r in FIG. 8.

In this way, unnecessary CPU-GPU transfer is blocked by the temporary area being created, parameters being initialized in the temporary area, and the parameters being used for CPU-GPU transfer. Although not intended by an OpenACC direction, transfer that degrades performance can be reduced.

### [GPU Offload Processing]

By the batch processing method of data transfer described above, a loop sentence appropriate for offloading can be extracted and inefficient data transfer can be avoided.

However, even in a case where the batch processing method of data transfer is used, there are programs that are not suitable for GPU offloading. For effective GPU offloading, the number of loops of offloading processing needs to be large.

Therefore, in the present embodiment, the number of loops is examined using a profiling tool as a preliminary stage of a full offload processing search. Since the number of times of execution in each row can be examined using a profiling tool, advance allocation such as, for example, setting a program having loops of 50 million times or more as a target of an offload processing search can be performed. Hereinafter, a specific description will be given (partially overlapping with the content described in FIG. 2).

In the present embodiment, first, an application for searching an offload processing part is analyzed, and loop sentences of for, do, while, and the like are grasped. Next, sample processing is executed, the number of loops of each of the loop sentences is examined using a profiling tool, and whether to perform an offload processing part search in full is determined depending on whether there are loops of a certain value or more.

In a case where it is determined that a search is to be performed in full, processing of the GA starts (see FIG. 2). In the initialization step, after whether all the loop sentences of the application code can be processed in parallel is checked, a case where GPU processing is performed on a parallelizable loop sentence is set to 1, a case where the GPU processing is not performed is set to 0, and mapping in a gene sequence is performed. A designated number of genes is prepared, and allocation of 1 or 0 is randomly performed on each value of the genes.

Here, in codes corresponding to the genes, an explicit direction of data transfer (#pragma acc data copyin/copyout/copy) is added from variable data reference relationship in loop sentences designated to be subjected to GPU processing.

In the evaluation step, benchmark performance measurement is performed by the codes corresponding to the genes being compiled, deployed in the verification machine, and executed. Fitness of genes having satisfactory performance patterns is evaluated as being high. As described above, a parallel processing direction row (for example, see the reference sign f in FIG. 4.) and a data transfer direction row (for example, see the reference sign h in FIG. 4, the reference sign i in FIG. 5, and the reference sign k in FIG. 6.) are inserted into the codes corresponding to the genes.

In the selection step, a designated number of genes having high fitness are selected on the basis of the fitness. In the present embodiment, roulette selection in accordance with the fitness and elite selection of the highest fitness gene are performed. In the crossover step, some genes are exchanged at a certain point between the selected individuals at a specific crossover rate Pc, and child individuals are created. In the mutation step, each value of the individual genes is changed from 0 to 1 or from 1 to 0 at a specific mutation rate Pm.

Once the mutation step is finished and a designated number of genes of the next generation have been generated, an explicit direction of data transfer is added similarly to the initialization step and the evaluation, selection, crossover and mutation steps are repeated.

Finally, in the end determination step, processing is ended after it is repeated the number of times corresponding to a designated number of generations, and the gene having the highest fitness is defined as a solution. Deployment in the production environment is performed again using the code pattern having the highest performance corresponding to the gene having the highest fitness, and it is provided to the user.

Hereinafter, implementation of the offload server 1 will be described. The present implementation is to confirm effectiveness of the present embodiment.

### [Implementation]

Implementation of automatic offloading a C/C++ application using a general-purpose PGI compiler will be described.

In the present implementation, a target application is an application in a C/C++ language, and GPU processing itself uses a conventional PGI compiler for description because the purpose is to confirm the effectiveness of GPU automatic offloading.

The C/C++ language is highly popular in development of open source software (OSS) and proprietary software, and many applications are developed in the C/C++ language. In order to confirm offloading of an application used by a general user, a general-purpose application of OSS such as encryption processing or image processing is used.

GPU processing is performed by a PGI compiler. The PGI compiler is a compiler for C/C++/Fortran that interprets OpenACC. In the present embodiment, parallelizable processing parts such as for sentences are designated by a directive #pragma acc kernels (parallel processing designation sentence) of OpenACC. As a result, a byte code for the GPU is extracted, and execution thereof enables GPU offloading. Furthermore, an error is generated in a case of processing in which data in the for sentences has dependency and parallel processing cannot be performed, a case where a plurality of different hierarchies of the for sentences in nests is designated, or the like. In addition, an explicit direction of data transfer can be performed by a directive such as #pragma acc data copyin/copyout/copy.

In accordance with the designation in the above #pragma acc kernels (parallel processing designation sentence), an explicit direction of data transfer is performed by #pragma acc data copyout (a [ . . . ]) of a copyin clause of OpenACC being inserted into the above-described position.

### <Operation Outline of Implementation>

An operation outline of the implementation will be described.

In the implementation, the following processing is performed.

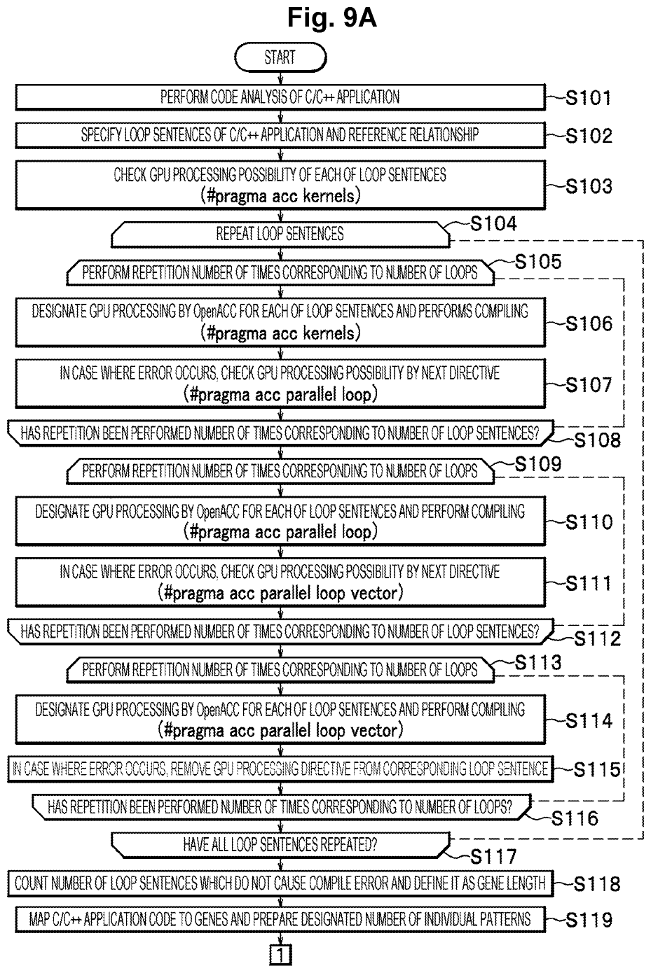

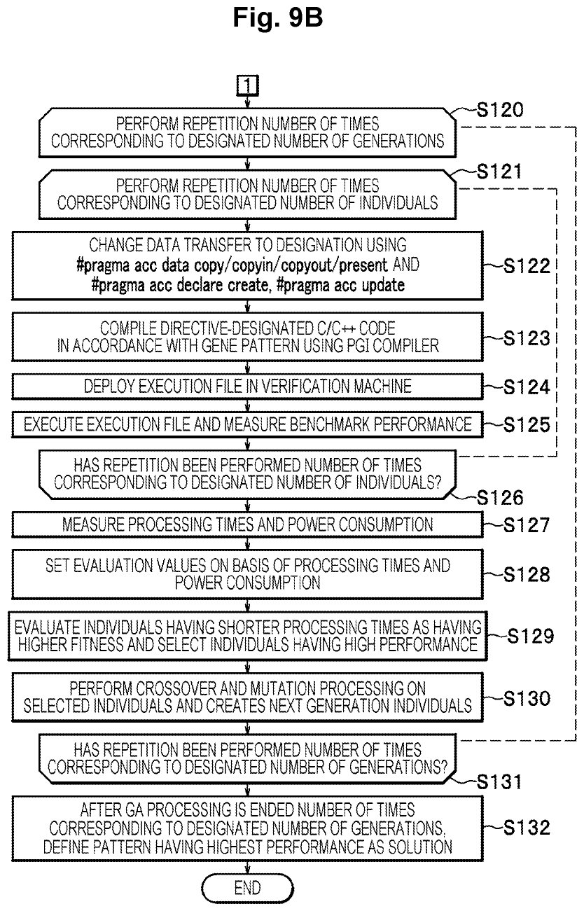

Before starting the processing of flows of FIGS. 9A-B below, a C/C++ application, the speed of which is to be increased, and a benchmark tool for measuring performance thereof are prepared.

In the implementation, when there is a use request of the C/C++ application, first, the code of the C/C++ application is analyzed to find for sentences, and a program structure such as variable data used in the for sentences is grasped. For the syntax analysis, a syntax analysis library of LLVM/Clang or the like is used.

In the implementation, first, in order to obtain a prospect of whether there is a GPU offload effect for the application, a benchmark is executed, and the numbers of loops of the for sentences grasped through the syntax analysis are grasped. For grasping the numbers of loops, gcov of GNU coverage or the like is used. As profiling tools, “GNU profiler (gprof)” and “GNU coverage (gcov)” are known. Since both can examine the number of times of execution in each row, either may be used. Regarding the number of times of execution, for example, only an application having the number of loops of 10 million times or more can be set as a target, but this value can be changed.

The general-purpose application for the CPU is not implemented on the assumption of parallelization. Therefore, first, a for sentence on which GPU processing itself cannot be performed needs to be excluded. Therefore, insertion of #pragma acc kernels, #prama acc parallel loop, or #prama acc parallel loop vector directive of GPU processing is tried for each of the for sentences, and whether an error occurs at the time of compiling is determined. There are several types of compile errors. There are a case where external routine is called in for sentences, a case where different hierarchies are redundantly designated in nest for sentences, a case where there is processing of breaking for sentences in the middle by break or the like, a case where data of for sentences has data dependency, and the like. There are various types of errors at the time of compiling depending on the application, and there are other cases, but compile errors are excluded from the processing target, and a #pragma directive is not inserted.

Compile errors are difficult to be automatically dealt with, and even if they are dealt with, effects are often not exerted. In a case of an external routine call, it may be avoided by #pragma acc routine, but many external calls are libraries, and even if GPU processing is performed including them, the calls become a bottleneck and performance cannot be achieved. Since the for sentences are tried one by one, no compile error occurs regarding an error of a nest. Furthermore, in a case where breaking in the middle is performed by break or the like, the number of loops needs to be fixed for parallel processing, and the program needs to be modified. In a case where there is data dependency, parallel processing itself cannot be performed in the first place.

Here, in a case where the number of loop sentences in which no error occurs even in a case where parallel processing is performed is a, a is set to the gene length. The application code is mapped to a gene having a length of a, where 1 and 0 of the gene correspond to presence and absence of a parallel processing directive, respectively.

Next, sequences of a designated number of genes are prepared as initial values. As described in FIG. 3, each value of the genes is created by 0 and 1 being randomly allocated. Depending on the prepared gene sequence, a directive ¥ #pragma acc kernels, ¥ #pragma acc parallel loop, ¥ #pragma acc parallel loop vector designating GPU processing is inserted into the C/C++ code in a case where the value of the gene is 1. The reason why a single loop and the like are not set to parallel is that a kernels has better performance as a PGI compiler in the same processing. At this stage, a portion to be processed by the GPU is determined in a code corresponding to a certain gene.

The C/C++ code into which a parallel processing and data transfer directives are inserted is compiled with a PGI compiler on a machine including a GPU. The compiled execution file is deployed and performance and power consumption are measured using a benchmark tool.

Benchmark performance is measured for all the individuals, and fitness of each of the gene sequences is then set in accordance with the benchmark processing time and power consumption. Individuals to be left are selected in accordance with the set fitness. GA processing including crossover processing, mutation processing, and direct copy processing is performed on the selected individuals, and a next generation individual group is created.

Directive insertion, compiling, performance measurement, fitness setting, selection, crossover, and mutation processing are performed on the next generation individuals. Here, in a case where genes of the same patterns as previous ones are generated in the GA processing, compiling and performance measurement are not performed on the individuals, and the same measurement values as previous ones are used.

After the GA processing is ended the number of times corresponding to a designated number of generations, a C/C++ code including a directive corresponding to the gene sequence having the highest performance is used as a solution.

At this time, the number of individuals, the number of generations, the crossover rate, the mutation rate, the fitness setting, and the selection method are parameters for the GA and are separately designated. The proposed technology automates the above processing to enable automation of GPU offloading, which has conventionally required a time and a skill of a technician.

FIGS. 9A-B are flowcharts for describing the operation outline of the above-described implementation, and FIGS. 9A and 9B are connected by a connector.

The following processing is performed using an OpenACC compiler for C/C++.

### <Code Analysis>

In step S101, the application code analysis unit 112 (see FIG. 1) performs code analysis of the C/C++ application.

### <Loop Sentence Specification>

In step S102, the parallel processing designation unit 114 (see FIG. 1) specifies loop sentences of the C/C++ application and reference relationship.

### <Loop Sentence Parallel Processing Possibility>

In step S103, the parallel processing designation unit 114 checks GPU processing possibility of each of the loop sentences (#pragma acc kernels).

### <Repetition of Loop Sentence>

The control unit (automatic offload functional unit) 11 repeats processing in steps S105-S116 the number of times corresponding to the number of the loop sentences between a loop start terminal in step S104 and a loop end terminal in step S117.

### <Repetition of Number of Loops (Part 1)>

The control unit (automatic offload functional unit) 11 repeats processing in steps S106-S107 the number of times corresponding to the number of the loop sentences between a loop start terminal in step S105 and a loop end terminal in step S108.

In step S106, the parallel processing designation unit 114 designates GPU processing (#pragma acc kernels) by OpenACC for each of the loop sentences and performs compiling.

In step S107, in a case where an error occurs, the parallel processing designation unit 114 checks GPU processing possibility by the next directive (#pragma acc parallel loop).

### <Repetition of Number of Loops (Part 2)>

The control unit (automatic offload functional unit) 11 repeats processing in steps S110-S111 the number of times corresponding to the number of the loop sentences between a loop start terminal in step S109 and a loop end terminal in step S112.

In step S110, the parallel processing designation unit 114 designates GPU processing (#pragma acc parallel loop) by OpenACC for each of the loop sentences and performs compiling.

In step S111, in a case where an error occurs, the parallel processing designation unit 114 checks GPU processing possibility by the next directive (#pragma acc parallel loop vector).

### <Repetition of Number of Loops (Part 3)>

The control unit (automatic offload functional unit) 11 repeats processing in steps S114-S115 the number of times corresponding to the number of the loop sentences between a loop start terminal in step S113 and a loop end terminal in step S116.

In step S114, the parallel processing designation unit 114 designates GPU processing (#pragma acc parallel loop vector) by OpenACC for each of the loop sentences and performs compiling.

In step S115, in a case where an error occurs, the parallel processing designation unit 114 removes a GPU processing directive from a corresponding loop sentence.

### <Count of Number of for Sentences>

In step S118, the parallel processing designation unit 114 counts the number of for sentences which do not cause a compile error and defines it as a gene length.

### <Preparation of Designated Number of Individual Patterns>

Next, the parallel processing designation unit 114 prepares sequences of a designated number of genes as initial values. Here, creation is performed by 0 and 1 being randomly allocated.

In step S119, the parallel processing designation unit 114 maps the C/C++ application code to the genes and prepares a designated number of individual patterns.

In a case where a gene value is 1, a directive of designating parallel processing is inserted into a C/C++ code in accordance with the prepared gene sequence (see the #pragma directive in FIG. 3, for example).

The control unit (automatic offload functional unit) 11 repeats processing in steps S121-S130 the number of times corresponding to a designated number of generations between a loop start terminal in step S120 and a loop end terminal in step S131.

Also, processing in steps S122-S125 is further repeated the number of times corresponding to the designated number of individuals between a loop start terminal in step S121 and a loop end terminal in step S126 in the above repetition performed the number of times corresponding to the designated number of generations. In other words, the repetition performed by the number of times corresponding to the designated number of individuals is processed in a nested state in the repetition performed the number of times corresponding to the designated number of generations.

### <Data Transfer Designation>

In step S122, the data transfer designation unit 113 performs data transfer designation using an explicit direction row (#pragma acc data copy/copyin/copyout/present and #pragam acc declarecreate, #pragma acc update) on the basis of the variable reference relationship.

### <Compiling>

In step S123, the parallel processing pattern creation unit 115 (see FIG. 1) compiles the directive-designated C/C++ code in accordance with the gene pattern using the PGI compiler. In other words, the parallel processing pattern creation unit 115 compiles the created code of the C/C++ using the PGI compiler on the verification machine 14 including a GPU.

Here, a compile error may occur in a case where a plurality of nest for sentences is designated in parallel or the like. This case is handled similarly to a case where the processing time at the time of performance measurement is timed out.

In step S124, the performance measurement unit 116 (see FIG. 1) deploys the execution file in the verification machine 14 including a CPU and a GPU mounted therein.

In step S125, the performance measurement unit 116 executes the arranged binary file and measures benchmark performance achieved when offloading is performed.

Here, measurement is not performed for genes having the same patterns as previous ones in the middle generations, and the same values are used. In other words, in a case where genes having the same patterns as previous ones are generated in the GA processing, compiling and performance measurement are not performed on the individuals, and the same measurement values as previous ones are used.

In step S127, the power consumption measurement unit 116b (see FIG. 1) measures processing times and power consumption.

In step S128, the evaluation value setting unit 116c (see FIG. 1) sets evaluation values on the basis of the measured processing times and power consumption.

In step S129, the execution file creation unit 117 (see FIG. 1) evaluates the individuals having higher evaluation values as having higher fitness and selects individuals having high performance. The execution file creation unit 117 selects patterns having short times and low power consumption from among a plurality of measured patterns as solutions.

In step S130, the execution file creation unit 117 performs crossover and mutation processing on the selected individuals and creates next generation individuals. The execution file creation unit 117 performs compiling, performance measurement, fitness setting, selection, crossover, and mutation processing on the next generation individuals.

In other words, benchmark performance is measured for all the individuals, and fitness of each of the gene sequences is then set in accordance with the benchmark processing time. Individuals to be left are selected in accordance with the set fitness. The execution file creation unit 117 performs GA processing including crossover processing, mutation processing, and direct copy processing on the selected individuals, and creates a next generation individual group.

In step S132, after the GA processing is ended the number of times corresponding to a designated number of generations, the execution file creation unit 117 defines a C/C++ code corresponding to the gene sequence having the highest performance (parallel processing pattern having the highest performance) as a solution.

### <Parameters for GA>

The number of individuals, the number of generations, the crossover rate, the mutation rate, the fitness setting, and the selection method described above are parameters for the GA. The parameters for the GA may be set as follows, for example.

The parameters and conditions for the Simple GA to be executed can be set as follows, for example.

Gene length: the number of parallelizable loop sentences

Number of individuals M: the gene length or less

Number of generations T: the gene length or less

Fitness: (processing time)^{(-1/2)}*(power consumption)^{(-1/2)}

With this setting, higher fitness is obtained as the benchmark processing time is shorter. Also, the fitness of a specific individual having a short processing time can be prevented from being excessively high and leading to a narrow search range, by the fitness being set to include the (−½) power of the processing time. Moreover, in a case where the performance measurement does not end in a specific period of time, the performance measurement is timed out and is regarded to have a processing time of 1000 seconds or the like (long time), and the fitness is calculated. The timeout time may be changed in accordance with performance measurement properties.

Selection: roulette selection

However, elite saving of saving the highest fitness gene in each generation for the next generation without performing crossover and mutation thereon is also performed together.
Crossover rate Pc: 0.9
Mutation rate Pm: 0.05

### <Cost Performance>

Cost performance of the automatic offloading function will be described.

In a case where attention is paid only to the price of hardware on a GPU board such as NVIDIA Tesla, the price of a machine including a GPU is about twice as that of a normal machine including only a CPU. However, in general, in the cost of a data center or the like, the cost of hardware and system development is ⅓ or less, the operation cost of an electricity charge, a maintenance/operation system, and the like is more than ⅓, and the other cost such as a service order is about ⅓. In the present embodiment, the performance of time-consuming processing in an application to be operated such as encryption processing or image processing can be doubled or more. Therefore, even if the server hardware price itself is doubled, a cost effect can be sufficiently expected.

In the present embodiment, gcov, gprof, or the like is used to specify an application that includes many loops and requires a long execution time in advance, and offload trial is performed thereon. As a result, an application, the speed of which can be efficiently increased, can be found.

### <Time Until Start of Actual Service Use>

The time until start of actual service use will be described.

Assuming that one time of performance measurement is performed for about 3 minutes after compiling, a solution search is performed for about 20 hours at maximum using the GA of 20 individuals and 20 generations, but compiling and measurement of the same gene patterns as before are omitted, and thus the processing is completed in 8 hours or less. In many cloud, hosting, and network services, it actually takes about half a day to start using the services. In the present embodiment, for example, automatic offloading within half a day is possible. Therefore, in a case of automatic offloading within half a day, if trial use is possible at first, it can be expected that the user satisfaction level is sufficiently increased.

In order to search for an offload portion in a shorter period of time, measuring performance in parallel in accordance with the number of individuals using a plurality of verification machines is conceivable. Adjusting a timeout time in accordance with the application also leads to a decrease in time. For example, processing is timed out in a case where the offload time is doubled as compared with the execution time of the CPU. Also, the probability that a high performance solution can be found increases as the number of individuals and the number of generations increase. However, compiling and performance benchmark need to be performed in accordance with the number of individuals*the number of generations in a case where each parameter is maximized. Therefore, it takes time to start actual service use. Although the GA is performed using a small number of individuals and a small number of generations in the present embodiment, a solution of performance that is high to some extent is found early by the crossover rate Pc being set to a value that is as high as 0.9 and a search for a wide range being performed.

### [Expansion of Directive]

In the present embodiment, in order to increase the number of applications that can be applied, a directive is expanded. Specifically, in addition to a kernels directive, a parallel loop directive and a parallel loop vector directive are also expanded as a directive designating GPU processing.

In the OpenACC standard, a kernels is used for a single loop and a tightly nested loop. Furthermore, a parallel loop is used for a loop including a non-tightly nested loop. A parallel loop vector is used for a loop that cannot be parallelized but can be vectorized. Here, the tightly nested loop is a simple loop in which, for example, in a case where two loops incrementing i and j are nested in nested loops, processing using i and j is performed in a lower loop and is not performed in a higher loop. Furthermore, in the implementation of the PGI compiler or the like, there is a difference that parallelization determination is performed by the compiler in a case of a kernels, and parallelization determination is performed by the programmer in a case of a parallel.

Therefore, in the present embodiment, a kernels is used for single and tightly nested loops, and a parallel loop is used for a non-tightly nested loop. Furthermore, a parallel loop vector is used for a loop that cannot be parallelized but can be vectorized.

Here, there is a concern that a parallel directive may lower reliability of the result as compared with a case of a kernels. However, it is assumed that a sample test is performed on a final offload program, a result difference from the CPU is checked, the result is presented to the user, and the user confirms the result. Since hardware is different between the CPU and the GPU in the first place, there is a difference in the number of significant digits, a rounding error, and the like, and a result difference from the CPU needs to be checked at least in a case of a kernels.

### [Evaluation]

The evaluation will be described.

In the [GPU automatic offloading of loop sentence] of the present embodiment, when an evaluation value of a measurement pattern is determined, offloading is performed using a method in which the evaluation value increases as the power decreases added to an existing implementation tool, and it is confirmed that the power can be reduced.

### <Evaluation Target>

The evaluation target is set to the Himeno benchmark of fluid calculation in the [GPU automatic offloading of loop sentence] of the present embodiment. In [FPGA automatic offloading of loop sentence] of a second embodiment to be described below, the evaluation target is set to MRI-Q that is a benchmark used in magnetic resonance imaging (MRI) image processing.

The Himeno benchmark solves 31 by performance measurement benchmark software of incompressible fluid analysis and the Poisson's equation by the Jacobi iteration method. Although the Himeno benchmark also includes C language and Fortran, since power measurement is performed, Python requiring a certain calculation time is used, and processing logic is described in Python. Data is calculated using a grid of 512*256*256 at Large (maximum). CPU processing is processed by Numpy in Python, and GPU processing is processed via a Cupy library that offloads a Numpy Interface to the GPU.

Note that MRI-Q will be described below in evaluation of the second embodiment.

### <Evaluation Method>

A code of a target application is input, and an offload pattern is determined by offloading of a loop sentence recognized by Clang or the like being tried for the migration destination GPU or FPGA. At this time, the processing time and the power consumption are measured. For the final offload pattern, a temporal change of the power consumption is acquired, and power reduction as compared with a case where all processing is performed by the CPU is confirmed.

In the [GPU automatic offloading of loop sentence] of the present embodiment, an appropriate pattern is selected by the GA. In the [FPGA automatic offloading of loop sentence] of the second embodiment to be described below, the GA is not performed, and measurement patterns are narrowed down to four patterns using arithmetic intensity or the like.

Offload target loop sentence: Himeno Benchmark 13

Pattern fitness: evaluation value indicated in Formula (1), that is, (processing time)^{-1/2}*(power consumption)^{-1/2}

As indicated in Formula (1), the shorter the processing time and the lower the power consumption, the higher the evaluation value and the higher the fitness.

### <Evaluation Environment>

Geforce RTX 2080 Ti is used in the [GPU automatic offloading of loop sentence] of the present embodiment. For power consumption, GPU power is measured by nvidia-smi (registered trademark) of NVIDIA and CPU power is measured by s-tui (registered trademark). Note that an Intel PAC with Intel Arria10 GXFPGA (registered trademark) is used for the [FPGA automatic offloading of loop sentence] of the second embodiment to be described below.

For power consumption, entire server power is measured using ipmitool (registered trademark) of intelligent platform management interface (IPMI) of a Dell (registered trademark) server.

### <Results and Discussion>

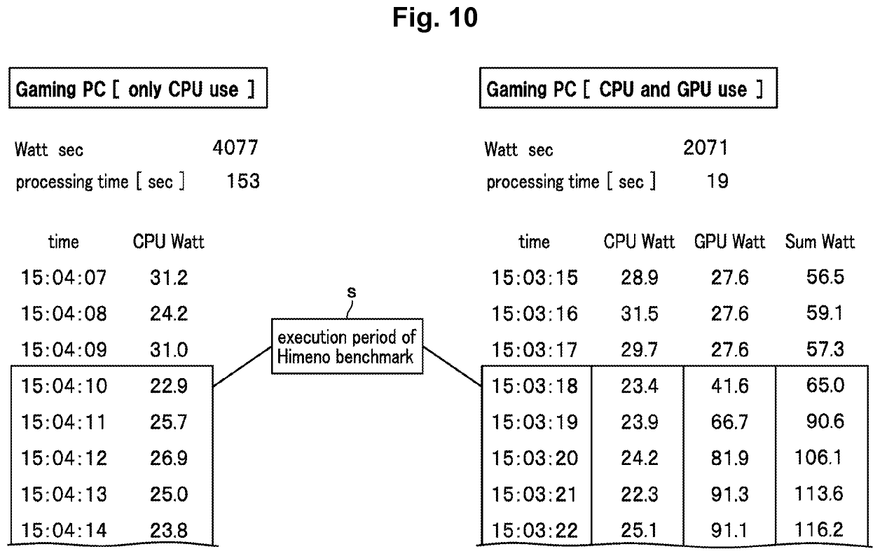

FIG. 10 is a diagram illustrating power consumption Watt and a processing time in a case where the Himeno benchmark is offloaded to the GPU.

In the reference sign s of FIG. 10, the power consumption Watt in each processing time of “all CPU processing” in the left part of FIG. 10 and “CPU and GPU processing” in the right part of FIG. 10 is illustrated in comparison.

As for the processing time in the Himeno benchmark, as compared with the “all CPU processing” in the left part of FIG. 10, it can be seen that, although the processing time of the “CPU and GPU processing” in the right part of FIG. 10 is shortened from 153 seconds to 19 seconds, the power consumption Watt increases from about 26.9 W at the maximum of the “all CPU processing” to about 116.2 W at the maximum of the “CPU and GPU processing”. As a result, the Watt sec of the “CPU and GPU processing” is 2071 Watt sec, which is about ½, from 4077 Watt sec of the case of the “all CPU processing”.

Furthermore, power reduction was confirmed for a plurality of applications. In the [GPU automatic offloading of loop sentence] of the present embodiment, although the power consumption Watt increases, a time effect of shortening the entire processing time can be obtained, and the power consumption can be reduced as a whole.

As described above, in the [GPU automatic offloading of loop sentence] of the present embodiment, automatic speed-up by the evolution calculation method of including power consumption in fitness and reduction of CPU-GPU transfer, and power reduction by evaluation of power consumption are implemented. In particular, when actual measurement is performed in the verification environment at the time of GPU automatic offloading, the power consumption is acquired in addition to the processing time, and a pattern having a short time and low power is set to have high fitness, and power reduction is incorporated into automatic code conversion. As described in the evaluation of FIG. 10, power reduction was confirmed through automatic offloading of the existing application, and the effectiveness was confirmed.

Next, an offload server 1A and the like according to the second embodiment of the present invention will be described.

The second embodiment is an example applied to FPGA automatic offloading of a loop sentence.

An example in which the present embodiment is applied to a field programmable gate array (FPGA) as a programmable logic device (PLD) will be described. The present invention is applicable to any programmable logic device.

### (Description of Principle)

Since predicting a loop to be offloaded in the FPGA to increase the speed is difficult, performing automatic measurement in a verification environment is proposed similar to the GPU. However, since it takes several hours or more for the FPGA to compile OpenCL and operate the OpenCL on an actual machine, the processing time gets enormous and measurement using the GA in the GPU automatic offloading cannot be repeatedly performed many times. Therefore, measurement is performed after possible loop sentences to be offloaded to the FPGA are narrowed down. Specifically, for found loop sentences, loop sentences having high arithmetic intensity are extracted using an arithmetic intensity analysis tool such as ROSE (registered trademark). Furthermore, loop sentences having a large number of loops are also extracted using a profiling tool such as gcov (registered trademark).

OpenCL conversion is performed using loop sentences having high arithmetic intensity and a large number of loops as possibilities. At the time of OpenCL conversion, a CPU processing program is divided into a kernel (FPGA) and a host (CPU) according to the OpenCL grammar. For the possible loop sentences, the created OpenCL is precompiled and loop sentences having high resource efficiency are found. In this case, since resources to be created are known in the middle of compiling, the loop sentences are further narrowed down to loop sentences having a sufficiently small resource amount to be used.

Since some possible loop sentences remain, the performance and the power consumption are actually measured using them. Selected single-loop sentences are compiled and measured, combination patterns are created for single-loop sentences that can be further sped up, and the second measurement is performed. A pattern having a short time and low power consumption is selected from among a plurality of the measured patterns as a solution.

For FPGA offloading of a loop sentence, measurement is performed after narrowing down is performed using arithmetic intensity or the like, and the evaluation value of a low power pattern is increased, thereby performing an automatic speed increase and power reduction.

### Second Embodiment

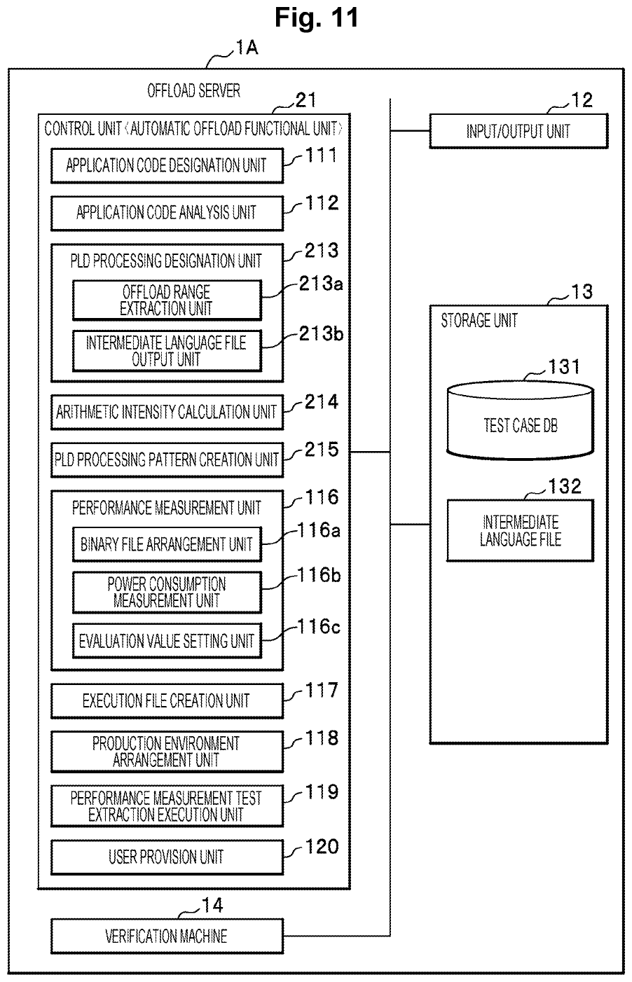

FIG. 11 is a functional block diagram illustrating a configuration example of the offload server 1A according to the second embodiment of the present invention. In the description of the present embodiment, the same components as those in FIG. 1 are denoted by the same reference signs, and the description of overlapping portions is omitted.

The offload server 1A is an apparatus that automatically offloads specific processing of an application to an accelerator.

Furthermore, the offload server 1A can be connected to an emulator.

As illustrated in FIG. 11, the offload server 1A includes a control unit 21, an input/output unit 12, a storage unit 13, and a verification machine 14 (accelerator verification apparatus).

The control unit 21 is an automatic offload functional unit (automatic offloading function) that is in charge of overall control of the offload server 1A. The control unit 21 is implemented by a CPU, which is not illustrated, developing and executing a program (offload program) stored in the storage unit 13 in the RAM, for example.

The control unit 21 Ides an application code designation unit (specify application code) 111, an application code analysis unit (analyze application code) 112, a PLD processing designation unit 213, an arithmetic intensity calculation unit 214, a PLD processing pattern creation unit 215, a performance measurement unit 116, an execution file creation unit 117, a production environment arrangement unit (deploy final binary files to production environment) 118, a performance measurement test extraction execution unit (extract performance test cases and run automatically) 119, and a user provision unit (provide price and performance to a user to judge) 120.

### <PLD Processing Designation Unit 213>

The PLD processing designation unit 213 specifies loop sentences (repeated sentences) of an application, creates a plurality of offload processing patterns in which pipeline processing or parallel processing in the PLD is designated by OpenCL for each of the specified loop sentences, and performs compiling.

The PLD processing designation unit 213 includes an offload range extraction unit (extract offload able area) 213a and an intermediate language file output unit (output intermediate file) 213b.

The offload range extraction unit 213a specifies processing that can be offloaded to an FPGA such as a loop sentence or an FFT and extracts an intermediate language in accordance with the offload processing.

The intermediate language file output unit 213b outputs an extracted intermediate language file 132. The extraction of the intermediate language is not ended when it is performed once and is repeated to try and optimize execution to search for an appropriate offload region.

### <Arithmetic Intensity Calculation Unit 214>

The arithmetic intensity calculation unit 214 calculates arithmetic intensity of a loop sentence of the application using, for example, an arithmetic intensity analysis tool such as ROSE framework (registered trademark). The arithmetic intensity is a value (FN operation/memory access) obtained by dividing the number of floating point number operations (floating point number, FN) executed during operation of a program by the number of accessed bytes in the main memory.

The arithmetic intensity is an index that increases in a case where the number of times of calculation is large and decreases in a case where the number of times of access is large, and processing having high arithmetic intensity is heavy processing for the processor. Therefore, arithmetic intensity of a loop sentence is analyzed by the arithmetic intensity analysis tool. The PLD processing pattern creation unit 215 performs narrowing down to loop sentences having high arithmetic intensity as offload possibilities.

An example of calculation of arithmetic intensity will be described.

It is assumed that floating point number calculation processing is performed 10 times (10FLOP) in one loop, and data used in the loop is 2 bytes. In a case where data of the same size is used for each loop, 10/2=5 [FLOP/byte] is the arithmetic intensity.

Note that since the number of loops is not considered in arithmetic intensity, narrowing down is performed in consideration of the number of loops in addition to arithmetic intensity in the present embodiment.

### <PLD Processing Pattern Creation Unit 215>

On the basis of the arithmetic intensity calculated by the arithmetic intensity calculation unit 214, the PLD processing pattern creation unit 215 performs narrowing down to loop sentences having arithmetic intensity higher than a predetermined threshold (hereinafter, referred to as high arithmetic intensity as appropriate) as offload possibilities, and creates PLD processing patterns.

Furthermore, the PLD processing pattern creation unit 215, as basic operation, excludes a loop sentence which causes a compile error from an offloading target and creates PLD processing patterns of designating whether to execute PLD processing on a repeated sentence which does not cause a compile error.

### Number of Loops Measurement Function

The PLD processing pattern creation unit 215 measures the numbers of loops of the loop sentences of the application using the profiling tool as a number of loops measurement function, and narrows down the loop sentences to loop sentences having high arithmetic intensity and a number of loops larger than a predetermined number of times (hereinafter, referred to as a large number of loops as appropriate). For grasping the numbers of loops, gcov of GNU coverage or the like is used. As profiling tools, “GNU profiler (gprof)” and “GNU coverage (gcov)” are known. Since both can examine the number of times of execution of each loop, either may be used.

Furthermore, since the number of loops is not particularly appeared in the arithmetic intensity analysis, the numbers of loops are measured using the profiling tool in order to detect a loop having a large number of loops and a high load. Here, the intensity of the arithmetic intensity indicates whether the processing is suitable for offloading to the FPGA, and the number of loops*the arithmetic intensity indicates whether the load related to the offloading to the FPGA is high.

### OpenCL (Intermediate Language) Creation Function

The PLD processing pattern creation unit 215 creates, as an OpenCL creation function, OpenCL for offloading each of the loop sentences obtained by narrowing down to the FPGA (OpenCL conversion). That is, the PLD processing pattern creation unit 215 compiles OpenCL for offloading the loop sentences obtained by narrowing down. Furthermore, the PLD processing pattern creation unit 215 creates a list of loop sentences having higher performance as compared with the CPU from among the loop sentences for which performance measurement has been performed, and creates OpenCL for offloading by combining the loop sentences in the list.

OpenCL conversion is described.

The PLD processing pattern creation unit 215 converts a loop sentence to a high-level language such as OpenCL. First, a CPU processing program is divided into a kernel (FPGA) and a host (CPU) according to the grammar of a high-level language such as OpenCL. For example, in a case where one for sentence of 10 for sentences is processed by the FPGA, one of the for sentences is cut out as a kernel program and described according to the OpenCL grammar. Grammar examples of OpenCL will be described below.

Furthermore, techniques for increasing the speed can be incorporated in the division. Generally, in order to increase the speed using the FPGA, there are local memory cache, stream processing, multiple instantiation, loop sentence unrolling processing, nested loop sentence integration, memory interleaving, and the like. These are not absolutely effective depending on the loop sentence, but are often used as a method for increasing the speed.

The kernel created in accordance with a C language grammar of OpenCL is executed by a device (for example, FPGA) on the basis of a created program on the host (for example, CPU) side using runtime API of the C language of OpenCL. A part of a kernel function hello ( ) called from the host side corresponds to calling of clEnqueueTask ( ) that is one of OpenCL runtime API.

A basic flow of initialization, execution, and end of OpenCL described in a host code includes steps 1 to 13 described below. Among steps 1 to 13, steps 1 to 10 are a procedure (preparation) until the kernel function hello ( ) is called from the host side, and the kernel is executed in step 11.

### 1. Platform Specification

A platform where OpenCL operates is specified using a function clGetPlatformIDs ( ) that provides a platform specification function defined by OpenCL runtime API.

### 2. Device Specification

A device such as a GPU used in the platform is specified using a function clGetDeviceIDs ( ) that provides a device specification function defined by OpenCL runtime API.

### 3. Context Creation

An OpenCL context that serves as an execution environment where OpenCL is caused to operate is created using a function clCreateContext ( ) that provides a context creation function defined by OpenCL runtime API.

### 4. Command Queue Creation

A command queue that is preparation for controlling a device is created using a function clCreateCommandQueue ( ) that provides a command queue creation function defined by OpenCL runtime API. In OpenCL, an action on the device from the host (issuing of a kernel execution command and a memory copy command between the host and the device) is executed through the command queue.

### 5. Memory Object Creation

A memory object that enables the host side to refer to the memory object is created using a function clCreateBuffer ( ) that provides a function of securing a memory on a device as defined by OpenCL runtime API.

### 6. Kernel File Reading

Execution itself of the kernel executed by the device is controlled by a host-side program. Therefore, the host program needs to read the kernel program first. The kernel program includes binary data created by an OpenCL compiler and a source code described in the OpenCL C language. The kernel file is read (description is omitted). Note that the OpenCL runtime API is not used in the reading of the kernel file.

### 7. Program Object Creation

In OpenCL, the kernel program is recognized as a program project. This procedure is program object creation.

A program object that enables the host side to refer to the memory object is created using a function clCreateProgramWithSource ( ) that provides a program object creation function defined by OpenCL runtime API. In a case where the program object is created from a compiled binary sequence of the kernel program, clCreateProgramWithBinary ( ) is used.

### 8. Building

A program object that is registered as a source code is built using an OpenCL C compiler linker.

The program object is built using a function clBuildProgram ( ) that executes the building using the OpenCL C compiler linker defined by OpenCL runtime API. Note that in a case where the program object is created from a binary sequence compiled by clCreateProgramWithBinary ( ) the compiling procedure is not necessary.

### 9. Kernel Object Creation

A kernel object is created using a function clCreateKernel ( ) that provides a kernel creation function defined by OpenCL runtime API. Since one kernel object corresponds to one kernel function, the name of the kernel function (hello) is designated when the kernel object is created. Also, in a case where a plurality of kernel functions is described as one program object, one kernel object corresponds to one kernel function in one-to-one relationship, clCreateKernel ( ) is called a plurality of times.

### 10. Kernel Argument Setting

A kernel argument is set using a function clSetKernel ( ) that provides a function of providing an argument to the kernel (passing a value to an argument that the kernel function has) as defined by OpenCL runtime API. As described above, the preparation ends in steps 1 to 10 above, and the processing proceeds to step 11 in which the kernel is executed by the device from the host side.

### 11. Kernel Execution

Kernel execution (input to a command queue) is an action on the device and is thus a queuing function in response to a command queue.

A command that executes the kernel hello in the device is queued using a function clEnqueueTask ( ) that provides a kernel execution function defined by OpenCL runtime API. After the command that executes the kernel hello is queued, the kernel hello is executed by an arithmetic operation unit that can execute the kernel hello on the device.

12. Reading from Memory Object

Data is copied from a device-side memory region to a host-side memory region using a function clEnqueueReadBuffer ( ) that provides a function of copying data from the device-side memory to the host-side memory as defined by OpenCL runtime API. Also, data is copied from the host-side memory region to the device-side memory region using a function clEnqueueWrightBuffer ( ) that provides a function of copying data from the host side to the device-side memory. Note that since these functions can act on the device, the data copying is started after the copy command is queued in response to the command queue once.

### 13. Object Release

Finally, various objects created so far are released.

The execution of the kernel created in accordance with the OpenCL C language achieved by the device has been described above.

### Resource Amount Calculation Function

As a resource amount calculation function, the PLD processing pattern creation unit 215 calculates used resource amounts by performing precompiling the created OpenCL (“first resource amount calculation”). The PLD processing pattern creation unit 215 calculates resource efficiency on the basis of the calculated arithmetic intensity and resource amounts, and selects c loop sentences having resource efficiency higher than a predetermined value from among each of the loop sentences on the basis of the calculated resource efficiency.

The PLD processing pattern creation unit 215 calculates used resource amounts by performing precompiling using the combined offload OpenCL (“second resource amount calculation”). Here, the sum of resource amounts in precompiling before the first measurement may be used without performing precompiling.

### <Performance Measurement Unit 116>

The performance measurement unit 116 compiles an application of a created PLD processing pattern, arranges the compiled application in the verification machine 14, and executes processing of measuring performance achieved when offloading to the PLD is performed.

The performance measurement unit 116 executes an arranged binary file, measures performance achieved when the offloading is performed, and returns the result of the performance measurement to the offload range extraction unit 213a. In this case, the offload range extraction unit 213a extracts another PLD processing pattern, and the intermediate language file output unit 213b tries the performance measurement on the basis of the extracted intermediate language (see the reference sign a in FIG. 2).

The performance measurement unit 116 includes a binary file arrangement unit (deploy binary files) 116a, a power consumption measurement unit 116b, and an evaluation value setting unit 116c. Note that the evaluation value setting unit 116c is included in the performance measurement unit 116, but may be another independent functional unit.

The binary file arrangement unit 116a deploys (arranges) an execution file derived from the intermediate language in the verification machine 14 including a GPU.

The power consumption measurement unit 116b measures a processing time and power consumption required at the time of FPGA offloading.

The evaluation value setting unit 116c sets an evaluation value including a processing time and power consumption and having a higher value as a processing time is shorter and power consumption is lower on the basis of a processing time and power consumption required at the time of FPGA offloading measured by the performance measurement unit 116 and the power consumption measurement unit 116b.

A specific example of the performance measurement will be described.

The PLD processing pattern creation unit 215 performs narrowing down to loop sentences having high resource efficiency, and compiles OpenCL for offloading the loop sentences obtained by narrowing down by the execution file creation unit 117. The performance measurement unit 116 measures performance of the compiled programs (“first performance measurement”).

Then, the PLD processing pattern creation unit 215 creates a list of loop sentences having higher performance as compared with the CPU from among the loop sentences for which performance measurement has been performed. The PLD processing pattern creation unit 215 creates OpenCL for offloading by combining the loop sentences on the list. The PLD processing pattern creation unit 215 calculates used resource amounts by performing precompiling using the combined offload OpenCL.

Note that the sum of resource amounts in precompiling before the first measurement may be used without performing precompiling. The execution file creation unit 117 compiles the combined offload OpenCL, and the performance measurement unit 116 measures performance of the compiled program (“second performance measurement”).

### <Execution File Creation Unit 117>

The execution file creation unit 117 selects a PLD processing pattern having the highest evaluation value from among a plurality of the PLD processing patterns on the basis of the result of repeating the measurement of a processing time and power consumption a predetermined number of times, compiles the PLD processing pattern having the highest evaluation value, and creates an execution file.

Hereinafter, an automatic offloading operation of the offload server 1A configured as described above will be described.

### [Automatic Offloading Operation]

The offload server 1A of the present embodiment is an example applied to FPGA automatic offloading of user application logic as an elemental technology of environment adaptive software.

The automatic offload processing of the offload server 1A illustrated in FIG. 2 described above will be described.

As illustrated in FIG. 2, the offload server 1A is applied to an elemental technology for environment adaptive software. The offload server 1A includes a control unit (automatic offload functional unit) 11, a test case DB 131, the intermediate language file 132, and the verification machine 14.

The offload server 1 acquires an application code 130 that the user uses.

The user uses, for example, various devices (Device) 151, an apparatus 152 including a CPU and a GPU, an apparatus 153 including a CPU and an FPGA, and an apparatus 154 including a CPU. The offload server 1 automatically offloads functional processing to accelerators of the apparatus 152 including the CPU and the GPU and the apparatus 153 including the CPU and the FPGA.

Hereinafter, operations of each component will be described with reference to step numbers in FIG. 2.

### <Step S21: Specify Application Code>

In step S21, the application code designation unit 111 (see FIG. 11) specifies a processing function (image analysis or the like) of a service provided to the user. Specifically, the application code designation unit 111 designates an input application code.

### <Step S12: Analyze Application Code>

In step S12, the application code analysis unit 112 (see FIG. 11) analyzes a source code of the processing function and recognizes structures of loop sentences and use of specific library such as an FFT library call.

### <Step S13: Extract Offload Able Area>

In step S13, the PLD processing designation unit 213 (see FIG. 11) specifies loop sentences (repeated sentences) of the application, designates parallel processing or pipeline processing in the FPGA for each of the repeated sentences, and performs compiling using a high-level synthesis tool. Specifically, the offload range extraction unit 213a (see FIG. 11) specifies processing that can be offloaded to the FPGA, such as loop sentences, and extracts OpenCL as an intermediate language in accordance with the offload processing.

### <Step S14: Output Intermediate File>

In step S14, the intermediate language file output unit 213b (see FIG. 11) outputs the intermediate language file 132. The extraction of the intermediate language is not ended when it is performed once and is repeated to try and optimize execution to search for an appropriate offload region.

### <Step S15: Compile Error>

In step S15, the PLD processing pattern creation unit 215 (see FIG. 11) excludes a loop sentence which causes a compile error from an offloading target and creates a PLD processing pattern of designating whether to execute FPGA processing on a repeated sentence which does not cause a compile error.

### <Step S21: Deploy Binary Files>

In step S21, the binary file arrangement unit 116a (see FIG. 11) deploys the execution file derived from the intermediate language in the verification machine 14 including an FPGA. The binary file arrangement unit 116a starts the arranged file, executes an assumed test case, and measures performance achieved when offloading is performed.

### <Step S22: Measure Performances>

In step S22, the performance measurement unit 116 (see FIG. 11) executes the arranged file and measures performance and power consumption achieved when offloading is performed.

In order to obtain a further appropriate offload region, the result of the performance measurement is returned to the offload range extraction unit 213a, and the offload range extraction unit 213a extracts another pattern. Then, the intermediate language file output unit 213b tries performance measurement on the basis of the extracted intermediate language (see the reference sign a in FIG. 2). The performance measurement unit 116 repeats performance and power consumption measurement in the verification environment and finally determines a code pattern to be deployed.

As illustrated by the reference sign a in FIG. 2, the control unit 21 repeatedly executes above steps S12 to S22. The automatic offloading function of the control unit 21 is summarized as follows. That is, the PLD processing designation unit 213 specifies loop sentences (repeated sentences) of the application, designates parallel processing or pipeline processing in the FPGA using OpenCL (intermediate language) for each of the repeated sentences, and performs compiling using a high-level synthesis tool. Then, the PLD processing pattern creation unit 215 excludes a loop sentence which causes a compile error from an offloading target and creates a PLD processing pattern of designating whether to execute PLD processing for a loop sentence which does not cause a compile error. Then, the binary file arrangement unit 116a compiles the application of the corresponding PLD processing pattern and arranges the compiled application in the verification machine 14, and the performance measurement unit 116 executes processing for measuring performance in the verification machine 14. The execution file creation unit 117 selects a pattern having the highest evaluation value (for example, pattern having the highest evaluation value obtained by evaluation value=(processing time)^{-1/2}*(power consumption)^{-1/2}) from among a plurality of PLD processing patterns on the basis of the result of repeating the measurement of performance and power consumption a predetermined number of times, compiles the selected pattern, and creates an execution file.

### <Step S23: Deploy Final Binary Files to Production Environment>

In step S23, the production environment arrangement unit 118 determines a pattern that designates a final offload region and deploys the pattern in the production environment for the user.

### <Step S24: Extract Performance Test Cases and Run Automatically>

In step S24, the performance measurement test extraction execution unit 119 extracts the performance test items from the test case DB 131 after the execution file is arranged, and automatically executes the extracted performance test to show the performance to the user.

### <Step S25: Provide Price and Performance to a User to Judge>

In step S25, the user provision unit 120 presents information regarding a price, performance, and the like based on the result of the performance test to the user. The user determines whether to start charged utilization of the service on the basis of the presented information regarding a price, performance, and the like.

Above steps S21 to S25 are performed in the background of the user's service utilization, and they are assumed to be performed on the first day of temporary utilization, for example. Furthermore, the processing performed in the background for cost reduction may be executed only for GPU and FPGA offloading.

As described above, in a case of an application to an elemental technology of environment adaptive software, the control unit (automatic offload functional unit) 21 of the offload server 1A extracts an offload region from the source code of the application that the user uses to offload the functional processing and outputs the intermediate language (steps S21 to S15). The control unit 21 arranges and executes, in the verification machine 14, the execution file derived from the intermediate language and verifies effects of the offloading (steps S21 and S22). After the verification is repeated, and an appropriate offload region is determined, the control unit 21 deploys the execution file in the production environment that is actually provided to the user and provides it as a service (steps S23 to S25).

Note that, in the above description, a processing flow for performing code conversion, resource amount adjustment, and arrangement place adjustment necessary for environment adaptation by batch has been described, but the present invention is not limited thereto, and only processing that is desirably performed can be cut out. For example, in a case where only code conversion for the FPGA is desirably performed, only necessary portions of the environment adaptation function, the verification environment, and the like in steps S21 to S21 described above may be used.

### [FPGA Automatic Offloading]

In the above-described code analysis, an application code is analyzed using a syntax analysis tool such as Clang. Since analysis needs to be performed on the assumption of a device to which offloading is performed, generalizing the code analysis is difficult. However, grasping a structure of a code such as a loop sentence and variable reference relationship and grasping that the functional block is a functional block on which FFT processing is to be executed, that a library for executing the FFT processing is being called, and the like are possible. It is difficult for the offload server to automatically determine the functional block. This can also be grasped by similarity determination or the like using a similar code detection tool such as Deckard. Here, Clang is a tool for C/C++, and a tool needs to be selected in accordance with a language to be analyzed.

Furthermore, in a case where processing of an application is offloaded, consideration needs to be performed in accordance with the offload destination in each of a GPU, an FPGA, an IoT GW, and the like. Generally, in terms of performance, automatically finding a setting having maximum performance at a time is difficult. Therefore, an offload pattern is tried by performance measurement being repeated several times in a verification environment, and a pattern that can increase the speed is found.

Hereinafter, an FPGA offloading method for application software loop sentences will be described.

### [Flowchart]

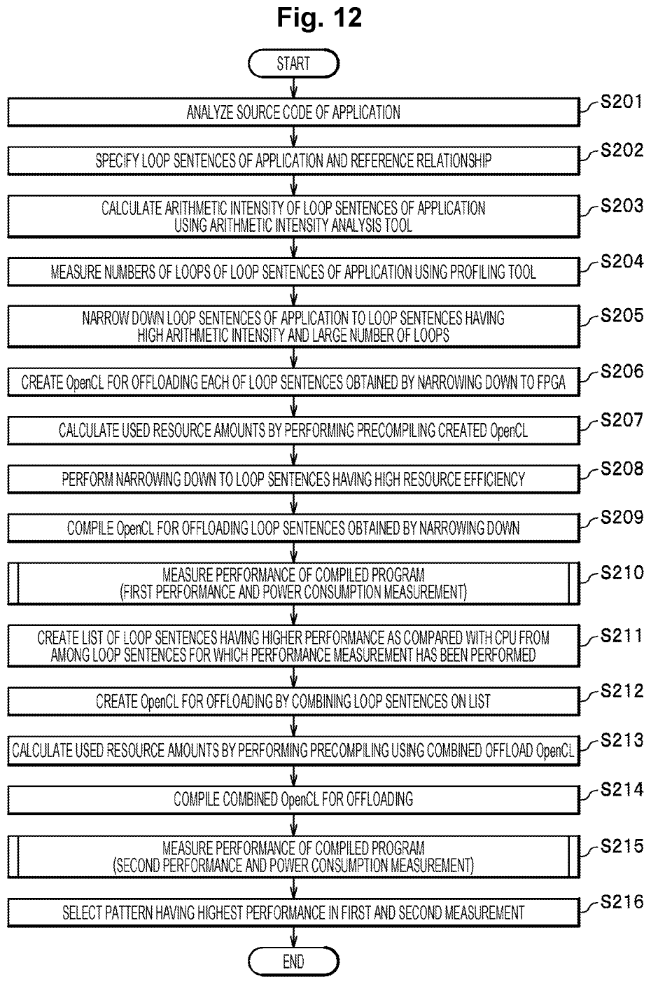

FIG. 12 is a flowchart for describing an operation outline of the offload server 1A.

In step S201, the application code analysis unit 112 analyzes a source code of an application that is desired to be offloaded. The application code analysis unit 112 analyzes information of loop sentences and variables in accordance with the language of the source code.

In step S202, the PLD processing designation unit 213 specifies loop sentences of the application and reference relationship.

Next, the PLD processing pattern creation unit 215 executes processing of narrowing down possibilities for whether to try FPGA offloading on the grasped loop sentences. The arithmetic intensity is one index of whether there is an offload effect for the loop sentences.

In step S203, the arithmetic intensity calculation unit 214 calculates the arithmetic intensity of the loop sentences of the application using an arithmetic intensity analysis tool. The arithmetic intensity is an index that increases in a case where the number of times of calculation is large and decreases in a case where the number of times of access is large, and processing having high arithmetic intensity is heavy processing for the processor. Therefore, the arithmetic intensity of the loop sentences is analyzed using the arithmetic intensity analysis tool, and narrowing down to loop sentences having high density as offload possibilities is performed.

Even if the loop sentence has high arithmetic intensity, it is an issue that FPGA resources are excessively consumed when the loop sentence is processed by the FPGA. Therefore, calculation of resource amounts when high arithmetic intensity loop sentences are subjected to FPGA processing will be described.

As processing at the time of performing compiling on the FPGA, a high-level language such as OpenCL is converted into a level of HDL or the like of hardware description, and actual wiring processing or the like is performed on the basis thereof. At this time, wiring processing or the like takes a lot of time, but it takes only minutes to reach a stage of an intermediate state of HDL or the like. Even in the stage of the intermediate state of HDL or the like, a resource such as Flip Flop and Look Up Table used in the FPGA can be known. Therefore, the used resource amounts can be known in a short time even if compiling is not completed, by looking at the stage of the intermediate state of HDL or the like.

Therefore, in the present embodiment, the PLD processing pattern creation unit 215 converts target loop sentences into a high-level language such as OpenCL and first calculates the resource amounts. Furthermore, since the arithmetic intensity and the resource amounts when the loop sentences are offloaded are determined, arithmetic intensity/resource amount or arithmetic intensity*the number of loops/resource amount is set as resource efficiency. Then, further narrowing down to loop sentences having high resource efficiency as offload possibilities is performed.

Returning to the flow of FIG. 12, in step S204, the PLD processing pattern creation unit 215 measures the numbers of loops of the loop sentences of the application using a profiling tool such as gcov or gprof.

In step S205, the PLD processing pattern creation unit 215 narrows down the loop sentences to loop sentences having high arithmetic intensity and a large number of loops.

In step S206, the PLD processing pattern creation unit 215 creates OpenCL for offloading each of the loop sentences obtained by narrowing down to the FPGA.

Here, OpenCL conversion of the loop sentences (creation of OpenCL) will be supplementarily described. That is, when a loop sentence is converted into a high-level language by OpenCL or the like, two types of processing is required. One is to divide a CPU processing program into a kernel (FPGA) and a host (CPU) according to the grammar of a high-level language such as OpenCL. The other is to incorporate techniques for increasing the speed in the division. Generally, in order to increase the speed using the FPGA, there are local memory cache, stream processing, multiple instantiation, loop sentence unrolling processing, nested loop sentence integration, memory interleaving, and the like. These are not absolutely effective depending on the loop sentence, but are often used as a method for increasing the speed.

Next, since some loop sentences having high resource efficiency are selected, offload patterns for actually measuring performance are created using the selected loop sentences as many as the number of times of actual measurement. In speeding up in the FPGA, there is a form in which the FPGA resource amount is intensively allocated to one piece of processing to increase the speed, and there is a form in which FPGA resources are distributed to a plurality of pieces of processing to increase the speed. A certain number of patterns of a selected single-loop sentence are created, and precompiling is performed as a preliminary stage of operation in the actual FPGA.

In step S207, the PLD processing pattern creation unit 215 calculates used resource amounts by performing precompiling the created OpenCL (“first resource amount calculation”).

In step S208, the PLD processing pattern creation unit 215 performs narrowing down to loop sentences having high resource efficiency.

In step S209, the execution file creation unit 117 compiles OpenCL for offloading the loop sentences obtained by narrowing down.

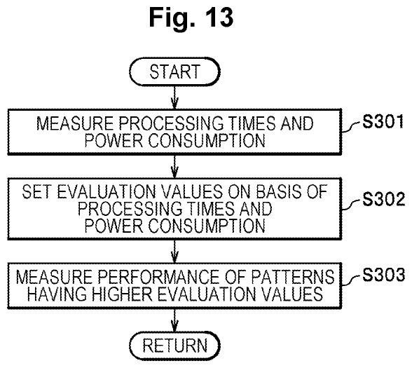

In step S210, the performance measurement unit 116 measures performance and power consumption of the compiled program (“first performance and power consumption measurement”). Since some possible loop sentences remain, the performance measurement unit 116 actually measures the performance and the power consumption using them. In order to also take power consumption into account when processing is offloaded to the FPGA, the power consumption is measured in addition to the performance (for details, see the subroutine in FIG. 13).

In step S211, the PLD processing pattern creation unit 215 creates a list of loop sentences having higher performance as compared with the CPU from among the loop sentences for which performance measurement has been performed.

In step S212, the PLD processing pattern creation unit 215 creates OpenCL for offloading by combining the loop sentences on the list.

In step S213, the PLD processing pattern creation unit 215 calculates used resource amounts by performing precompiling using the combined offload OpenCL (“second resource amount calculation”). Note that the sum of resource amounts in precompiling before the first measurement may be used without performing precompiling. In this way, the number of times of precompiling can be reduced.

In step S214, the execution file creation unit 117 compiles the combined offload OpenCL.

In step S215, the performance measurement unit 116 measures performance of the compiled program (“second performance and power consumption measurement”). The performance measurement unit 116 compiles and measures the selected single-loop sentences, creates combination patterns for single-loop sentences that can be further sped up, and performs the second performance and power consumption measurement (for details, see the subroutine in FIG. 13).

In step S216, the production environment arrangement unit 118 selects a pattern having the highest performance in the first and second measurement and ends the processing of this flow. A pattern having a short time and low power consumption is selected from among a plurality of the measured patterns as a solution.

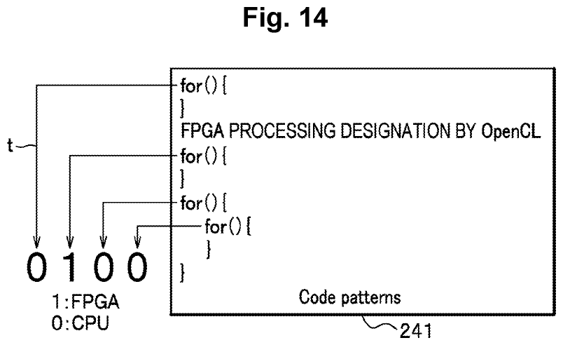

As described above, in the FPGA automatic offloading of a loop sentence, only loop sentences having high arithmetic intensity, a large number of loops, and high resource efficiency are obtained by narrowing down, offload patterns are created, and a high-speed pattern is searched for through actual measurement in the verification environment (see FIG. 14).

FIG. 13 is a flowchart illustrating performance and power consumption measurement processing of the performance measurement unit 116. The present flow is called by the subroutine call in step S211 or step S215 in FIG. 12, and executed.

In step S301, the power consumption measurement unit 116b measures processing times and power consumption required at the time of FPGA offloading.

In step S302, the evaluation value setting unit 116c sets evaluation values on the basis of the measured processing times and power consumption.

In step S303, the performance measurement unit 116 measures performance and power consumption of patterns having higher evaluation values evaluated such that the higher the evaluation values, the higher the fitness, and returns to step S211 or step S215 in FIG. 12.

### [Creation Example of Offload Pattern]

FIG. 14 is a diagram illustrating a search image of the PLD processing pattern creation unit 215.

The control unit (automatic offload functional unit) 21 (see FIG. 11) analyzes the application code 130 (see FIG. 2) that the user uses and checks whether for sentences can be processed in parallel from code patterns 241 of the application code 130 as illustrated in FIG. 14. In a case where four for sentences are found from the code patterns 241 as indicated by the reference sign t in FIG. 14, one digit is allocated to each of the for sentences, and in this case, four digits of 1 or 0 are allocated to the four for sentences. Here, 1 is set in a case where FPGA processing is performed, and 0 is set in a case where FPGA processing is not performed (that is, case where processing is performed by the CPU).

[Flow of Search for OpenCL Final Solution from C Code]

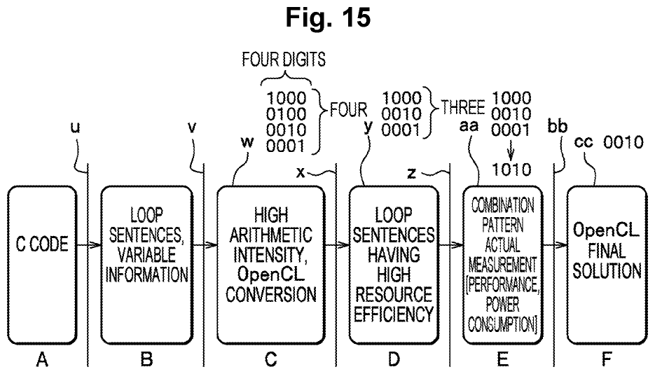

Procedures A-F of FIG. 15 are diagrams illustrating a flow of a search for an OpenCL final solution from a C code.

The application code analysis unit 112 (see FIG. 11) performs syntax analysis for “C code” illustrated in the procedure A of FIG. 15 (<syntax analysis>: see the reference sign u of FIG. 15), and the PLD processing designation unit 213 (see FIG. 11) specifies “loop sentences, variable information” illustrated in the procedure B of FIG. 15 (see FIG. 14).

The arithmetic intensity calculation unit 214 (see FIG. 11) performs arithmetic intensity analysis on the specified “loop sentences, variable information” using an arithmetic intensity analysis tool. The PLD processing pattern creation unit 215 performs narrowing down to loop sentences having high arithmetic intensity as offload possibilities. Furthermore, the PLD processing pattern creation unit 215 performs profiling analysis using a profiling tool (<intensity analysis>: see the reference sign v in FIG. 15), and further performs narrowing down to loop sentences having high arithmetic intensity and a large number of loops.

Then, the PLD processing pattern creation unit 215 creates OpenCL for offloading each of the loop sentences obtained by narrowing down to the FPGA (OpenCL conversion).

Furthermore, a speed-up method such as unrolling (described below) is introduced together with code division at the time of OpenCL conversion.

### < “High Arithmetic Intensity, OpenCL Conversion” Specific Example (Part 1): Procedure C>

For example, in a case where four for sentences (four digit allocation of 1 or 0) are found from the code pattern 241 (see FIG. 14) of the application code 130, narrowing down to (selecting) three is performed by the arithmetic intensity analysis. That is, as indicated by the reference sign w in FIG. 15, offload patterns of three for sentences “1000”, “0010”, and “0001” are obtained by the narrowing down from the four for sentences.

< “Unrolling” Example Executed Together with Code Division at the Time of OpenCL Conversion>

¥pragma unroll is directed above a loop sentence [k = 0; k
< 10; k++] {
}

described on the CPU program side in a case where data is transferred from the FPGA to the CPU. That is,

¥pragma unroll
for(k = 0; k < 10; k++) {
}

is described.

In a case where unroll is directed using a grammar suitable for a tool of Intel or Xilinx (registered trademark) such as ¥pragma unroll, unrolling can be performed like i=0, i=1, and i=2 and pipeline execution can be performed in a case of the above unrolling example. For this reason, although 10 times more of the resource amount is used, the speed may be increased.

Furthermore, the number obtained by unrolling using unroll can be designated, for example, as five instead of the total number of loops, and in this case, two loops are unrolled into five.

This is the end of the description of the “unrolling” example.

Next, the PLD processing pattern creation unit 215 further narrows down the loop sentences having high arithmetic intensity obtained by narrowing down as offload possibilities using resource amounts. That is, the PLD processing pattern creation unit 215 calculates resource amounts, and the PLD processing pattern generation unit 215 analyzes resource efficiency (=arithmetic intensity/resource amount used in FPGA processing or arithmetic intensity*number of loops/resource amount used in FPGA processing) from the offload possibilities of the loop sentences having high arithmetic intensity, and extracts loop sentences having high resource efficiency.

In the reference sign x in FIG. 15, the PLD processing pattern creation unit 215 compiles OpenCL for offloading the loop sentences obtained by narrowing down (<precompiling>).

### < “High Arithmetic Intensity, OpenCL Conversion” Specific Example (Part 2)>

As indicated by the reference sign y in FIG. 15, the four offload patterns “1000”, “0100”, “0010”, and “0001” obtained by narrowing down by the arithmetic intensity analysis are narrowed down to three offload patterns “1000”, “0010”, and “0001” by the above resource efficiency analysis.

The “high arithmetic intensity, OpenCL conversion” illustrated in the procedure C of FIG. 15 has been described above.

For the “loop sentences having high resource efficiency” illustrated in the procedure D of FIG. 15, the performance measurement unit 116 measures performance of the compiled programs (“first performance measurement”).

Then, the PLD processing pattern creation unit 215 creates a list of loop sentences having higher performance as compared with the CPU from among the loop sentences for which performance measurement has been performed. Hereinafter, similarly, the resource amounts are calculated, offload OpenCL compilation is performed, and performance of the compiled programs is measured.

### < “High Arithmetic Intensity, OpenCL Conversion” Specific Example (Part 3)>

As indicated by the reference sign y in FIG. 15, the first measurement is performed on the three offload patterns “1000”, “0010”, and “0001”. If performance of two that is “1000” and “0010” is higher among measurement of the three, the second measurement is performed on a combination of “1000” and “0010”.

In the reference sign z in FIG. 15, the execution file creation unit 117 compiles OpenCL for offloading the loop sentences obtained by narrowing down (<main compiling>).

The “combination pattern actual measurement” illustrated in the procedure E of FIG. 15 means that verification pattern measurement is performed using possible loop sentences alone and then a combination thereof.

### < “High Arithmetic Intensity, OpenCL Conversion” Specific Example (Part 4)>

As indicated by the reference sign aa in FIG. 15, the second measurement is performed on “1010” that is the combination of “1000” and “0010”. Measurement has been performed twice, and as a result, “00010” having the maximum speed has been selected from the first measurement and the second measurement. In such a case, “0010” is the final solution. Here, there is a case where a combination pattern cannot be measured due to resource amount limitation. In this case, the combination may be skipped, and the one having the highest speed may be selected from results of singles.

In the reference sign bb in FIG. 15, the performance measurement unit 116 selects “0010” having the highest speed and a satisfactory power consumption from the first measurement and the second measurement (<selection>).

As described above, “00010” (see the reference sign cc in FIG. 15) of “OpenCL final solution” illustrated in the procedure F in FIG. 15 has been selected.

### <Deployment (Arrangement)>

Deployment in the production environment is performed again using the PLD processing pattern of the OpenCL final solution having the highest processing performance, and it is provided to the user.

### [Implementation Example]

An implementation example will be described.

As the FPGA, an Intel PAC with Intel Arria 10 GX FPGA or the like can be used.

For FPGA processing, Intel Acceleration Stack (Intel FPGA SDK for OpenCL, Quartus Prime Version) or the like can be used.

The Intel FPGA SDK for OpenCL is a high-level synthesis tool (HLS) that interprets #pragma and the like for Intel in addition to the standard OpenCL.

In the implementation example, an OpenCL code in which the kernel processed by the FPGA and the host program processed by the CPU are described is interpreted and information such as a resource amount is output, and wiring work or the like of the FPGA is performed so that operation can be performed in the FPGA. It takes a long time of about 3 hours to enable operation even of a small program of about 100 rows using the actual FPGA. However, when the resource amount is inefficient, an error occurs early. Furthermore, in a case of an OpenCL code that cannot be processed by the FPGA, an error is output after several hours.

In the implementation example, when there is a use request of the C/C++ application, first, the code of the C/C++ application is analyzed to find for sentences, and a program structure such as variable data used in the for sentences is grasped. For the syntax analysis, a syntax analysis library of LLVM/Clang or the like can be used.

In the implementation example, next, an arithmetic intensity analysis tool is executed and indexes of arithmetic intensity determined by the number of times of calculation, the number of times of access, and the like are acquired in order to obtain prospect of whether there is an FPGA offload effect for each of the loop sentences. ROSE framework or the like can be used for the arithmetic intensity analysis. Only loop sentences having higher arithmetic intensity are targeted.

Next, the number of loops for each of the loop sentences is acquired using a profiling tool such as gcov. Narrowing down to top a loop sentences having larger values obtained by arithmetic intensity*number of loops as possibilities is performed.

In the implementation example, next, an OpenCL code for FPGA offloading is generated for each of the loop sentences having high arithmetic intensity. The OpenCL code is obtained by division into a corresponding loop sentence as an FPGA kernel and the rest as a CPU host program. In a case of setting the FPGA kernel code, loop sentence unrolling processing may be performed a certain number b of times as a technique of increasing the speeding. Although the resource amount increases, the loop sentence unrolling processing is effective for increasing the speed. Therefore, the number obtained by unrolling is limited to the certain number b and unrolling is performed within a range in which the resource amount is not enormous.

In the implementation example, next, OpenCL codes are precompiled using Intel FPGA SDK for OpenCL, and the resource amounts of used Flip Flop, Look Up Table, and the like are calculated. The used resource amounts are each displayed as a ratio of the total resource amount. Here, the resource efficiency of each of the loop sentences is calculated from the arithmetic intensity and the resource amount, or the arithmetic intensity, the number of loops, and the resource amount. For example, the resource efficiency of a loop sentence having arithmetic intensity of 10 and a resource amount of 0.5 is 10/0.5=20, the resource efficiency of a loop sentence having arithmetic intensity of 3 and a resource amount of 0.3 is 3/0.3=10, and the former is higher. Furthermore, a value multiplied by the number of loops may be used as resource efficiency. From the loop sentences, c loop sentences having high resource efficiency are selected.

In the implementation example, next, patterns for actual measurement are created using the c loop sentences as possibilities. For example, in a case where the first and third loops have high resource efficiency, OpenCL patterns, each of which is for offloading the first loop and offloading the third loop, are created and compiled, and performance is measured. In a case where the speed can be increased by offload patterns of a plurality of single loop sentences (for example, in a case where both the first and the third can be sped up), an OpenCL pattern of a combination thereof is created and compiled, and performance is measured (for example, a pattern in which both the first and third are offloaded).

Note that, in a case where a combination of single loops is created, the use resource amounts are also combined. Therefore, in a case where the resource amount does not fall within the upper limit value, the combination pattern is not created. In a case where d patterns including a combination are created, performance measurement is performed by a server including an FPGA of a verification environment. For the performance measurement, sample processing designated by an application to be desirably sped up is performed. For example, in a case of a Fourier transform application, performance measurement is performed using transform processing using sample data as a benchmark.

In the implementation example, finally, a high-speed pattern of a plurality of measurement patterns is selected as a solution.

### [Evaluation]

The evaluation will be described.

In the [FPGA automatic offloading of loop sentence] of the second embodiment, similarly to the [GPU automatic offloading of loop sentence] of the first embodiment, when an evaluation value of a measurement pattern is determined, offloading is performed using a method in which the evaluation value increases as the power decreases added to an existing implementation tool, and it is confirmed that the power can be reduced.

### <Evaluation Target>

In the [FPGA automatic offloading of loop sentence] of the second embodiment, the evaluation target is set to MRI-Q of magnetic resonance imaging (MRI) image processing.

MRI-Q calculates a matrix Q representing a scanner configuration used in a non-Cartesian space three-dimensional MRI reconstruction algorithm. MRI-Q is described in C language, executes three-dimensional MRI image processing during performance measurement, and measures a processing time using Large (maximum) 64*64*64 size data. The CPU processing uses C language, and FPGA processing is performed on the basis of OpenCL.

### <Evaluation Method>

A code of a target application is input, and an offload pattern is determined by offloading of a loop sentence recognized by Clang or the like being tried for the migration destination GPU or FPGA. At this time, the processing time and the power consumption are measured. For the final offload pattern, a temporal change of the power consumption is acquired, and power reduction as compared with a case where all processing is performed by the CPU is confirmed.

In the [FPGA automatic offloading of loop sentence] of the second embodiment, the GA is not performed, and measurement patterns are narrowed down to four patterns using arithmetic intensity or the like.

Offload target loop sentence: MRI-Q 16

Pattern fitness: evaluation value indicated in Formula (1), that is, (processing time)^{-1/2}*(power consumption)^{-1/2}

As indicated in Formula (1), the shorter the processing time and the lower the power consumption, the higher the evaluation value and the higher the fitness.

### <Evaluation Environment>

In the [FPGA automatic offloading of loop sentence] of the second embodiment, an Intel PAC with Intel Arria10 GX FPGA (registered trademark) is used. For power consumption, entire server power is measured using ipmitool (registered trademark) of intelligent platform management interface (IPMI) of a Dell (registered trademark) server.

### <Results and Discussion>

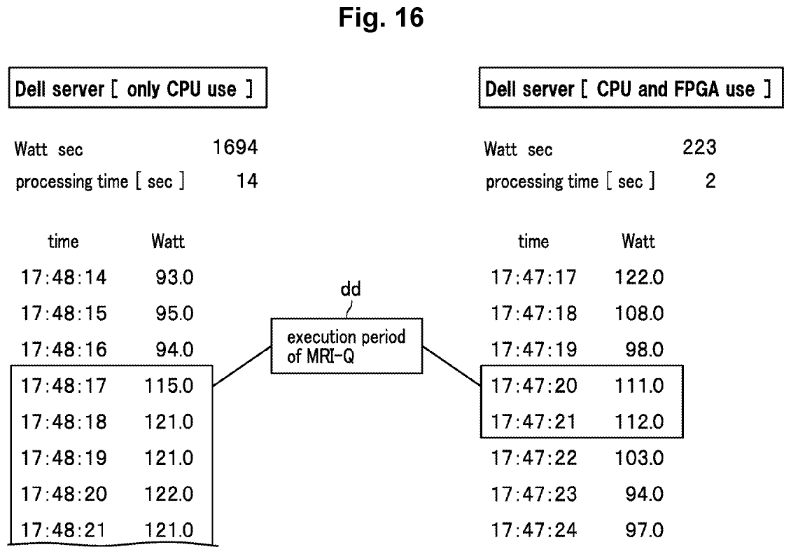

FIG. 16 is a diagram illustrating power consumption Watt and a processing time in a case where MRI-Q is offloaded to the FPGA.

In the reference sign dd of FIG. 16, the power consumption Watt in each processing time of “all CPU processing” in the left part of FIG. 16 and “CPU and FPGA processing” in the right part of FIG. 16 is illustrated in comparison.

As for the processing time in MRI-Q, as compared with the “all CPU processing” in the left part of FIG. 16, it can be seen that the processing time of the “CPU and FPGA processing” in the right part of FIG. 16 is shortened from 14 seconds to 2 seconds, and the power consumption Watt is also reduced from about 122.2 W at the maximum of the “all CPU processing” to about 112.0 W at the maximum of the “CPU and FPGA processing”. As a result, the Watt sec of the “CPU and FPGA processing” is 223 Watt sec, which is about ⅛, from 1694 Watt sec of the “all CPU processing”.

Furthermore, power reduction was confirmed for a plurality of applications. In the [FPGA automatic offloading of loop sentence] of the second embodiment, the power can be greatly reduced by the synergistic effect due to time shortening in addition to the fact that the power consumption Watt is reduced. It is generally said that the FPGA has satisfactory power efficiency, and it was confirmed that the power consumption of the FPGA is low also in the experiment. Therefore, selecting the FPGA in a case where performance achieved when offloading is performed in a mixed environment is similar is conceivable.

As described above, in the [FPGA automatic offloading of loop sentence] of the second embodiment, automatic speed-up by the method of including power consumption in fitness, and power reduction by evaluation of power consumption are implemented. In particular, when actual measurement is performed in the verification environment at the time of FPGA automatic offloading, the power consumption is acquired in addition to the processing time, and a pattern having a short time and low power is set to have high fitness, and power reduction is incorporated into automatic code conversion. As described in the evaluation of FIG. 16, power reduction was confirmed through automatic offloading of the existing application, and the scheme effectiveness was confirmed.

### [Automatic Offloading in Mixed Environment]

A technique of selecting a high-performance migration destination and performing offloading in a state where a GPU, an FPGA, and a many-core CPU are mixed as migration destinations will be described.

The offload server 1 (see FIG. 1) and the offload server 1A (see FIG. 11) are combined (hereinafter, for convenience of description, the combined server is referred to as an offload server 1, 1A).

The offload server 1, 1A offloads application specification processing to at least one of the GPU, the many-core CPU, or the PLD.

The offload server 1, 1A includes the parallel processing pattern creation unit 115 (see FIG. 1) that excludes a loop sentence for a GPU or a loop sentence for a many-core CPU which causes a compile error from an offloading target and creates a parallel processing pattern of designating whether to execute parallel processing for a loop sentence for a GPU or a loop sentence for a many-core CPU which does not cause a compile error, and the performance measurement unit 116 (see FIGS. 1 and 11) that compiles an application of a parallel processing pattern or a PLD processing pattern in a mixed environment of a GPU, a many-core CPU, and a PLD, arranges the application in an accelerator verification apparatus, and executes processing of measuring each piece of performance achieved when offloading to the GPU, the many-core CPU, and the PLD is performed.

Furthermore, the offload server 1, 1A includes the evaluation value setting unit 116c (see FIGS. 1 and 11) that sets an evaluation value including a processing time and power consumption and having a higher value as a processing time is shorter and power consumption is lower on the basis of a processing time and power consumption required at the time of offloading the GPU, the many-core CPU, and the PLD measured by the performance measurement unit 116, and the execution file creation unit 117 (see FIGS. 1 and 11) that selects one having the processing time and the power consumption that are the best from among the GPU, the many-core CPU, and the PLD on the basis of a measurement result of the processing time and the power consumption of the GPU, the many-core CPU, and the PLD, selects a parallel processing pattern or PLD processing pattern having the highest evaluation value from among a plurality of the parallel processing patterns or PLD processing patterns for the selected one, compiles the parallel processing pattern or PLD processing pattern having the highest evaluation value, and creates an execution file.

As a verification order, verification is performed by offloading of a loop sentence for a many-core CPU, offloading of a loop sentence for a GPU, and offloading of a loop sentence for an FPGA, and a pattern having high performance is searched for. In automatic offloading, it is expected that the pattern search is performed at a minimum cost in a short time. Therefore, the FPGA that requires a long verification time is set to the last, and the FPGA verification is not performed if a pattern that satisfies a sufficient user requirement has been found at a previous stage.

Regarding the GPU and the many-core CPU, there is no large difference in terms of the price and verification time, however, since the difference between the many-core CPU and a normal CPU is smaller as compared to the GPU in which the memory is a separate space and the device itself is different, the many-core CPU is set to the first in the verification order, and GPU verification is not performed if a pattern that sufficiently satisfies the user requirement has been found in the many-core CPU.

As described above, the three migration destinations of the GPU, the FPGA, and the many-core CPU are verified, and a high-speed migration destination is automatically selected.

As described in each embodiment described above, when automatically selecting a high-speed migration destination, a migration destination having not only a short processing time but also low-power is set as a possibility for automatic selection through actual measurement in the verification environment. For example, the evaluation formula may be set such that the shorter the processing time and the lower the power consumption, the higher the score, such as evaluation value=(processing time)^{-1/2}*(power consumption)^{-1/2}.

An example of the cost of a typical data center is that an initial cost such as a hardware and development cost is ⅓ of the total cost, an operation cost such as power and maintenance is ⅓, and the other cost such as a service order is ⅓. In this case, for example, the processing time is ⅕, and the initial cost is also reduced if the number of hardware devices including a CPU and a GPU is halved. Halving power consumption also leads to a reduction in the operation cost. However, the operation cost includes many factors other than power, and halving of the power consumption does not mean halving of the operation cost. Furthermore, the hardware price also includes a volume discount and the like depending on the number of GPU and FPGA servers to be introduced, and differs depending on the business operator. Therefore, the evaluation formula needs to be set differently depending on the business operator.

In this way, an appropriate offload destination is automatically selected in consideration of not only a processing time but also power consumption. Since it is generally said that an FPGA has better power efficiency than a CPU or a GPU, selecting the FPGA having satisfactory power efficiency as an offload destination is conceivable if, as a result of actual measurement, the reduction in processing time after offloading is similar.

### [Hardware Configuration]

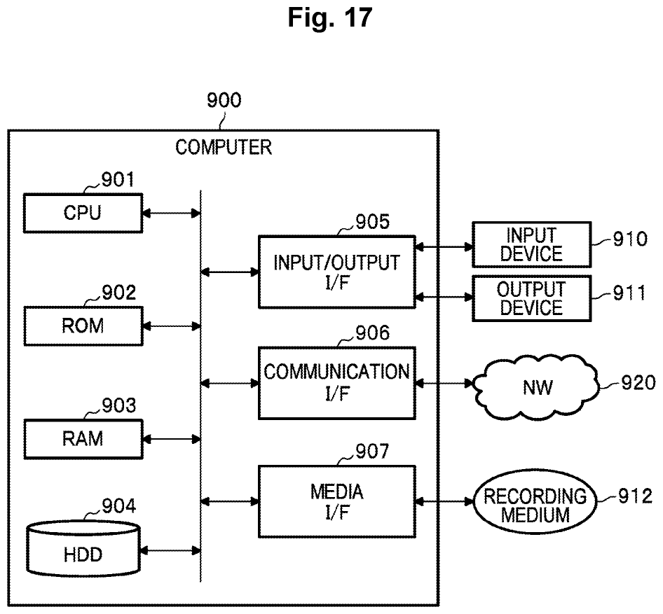

The offload servers according to the first and second embodiments are implemented by a computer 900 that is a physical apparatus as illustrated in FIG. 17, for example.

FIG. 17 is a hardware configuration diagram illustrating an example of a computer that implements functions of the offload server 1, 1A. The computer 900 includes a central processing unit (CPU) 901, a read only memory (ROM) 902, a RAM 903, a hard disk drive (HDD) 904, an input/output interface (I/F) 905, a communication I/F 906, and a media I/F 907.

The CPU 901 operates on the basis of a program stored in the ROM 902 or the HDD 904 and performs control of each processing unit in the offload server 1,1A illustrated in FIGS. 1 and 11. The ROM 902 stores a boot program to be executed by the CPU 901 when the computer 900 is started, a program related to hardware of the computer 900, and the like.

The CPU 901 controls, via the input/output I/F 905, an input device 910 such as a mouse or a keyboard, and an output device 911 such as a display. The CPU 901 acquires data from the input device 910 and outputs generated data to the output device 911 via the input/output I/F 905.

The HDD 904 stores a program to be executed by the CPU 901, data to be used by the program, and the like. The communication I/F 906 receives data from another device via a communication network (for example, network (NW) 920), outputs the data to the CPU 901, and transmits data generated by the CPU 901 to another device via the communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

In a case where the computer 900 functions as the offload server 1, 1A according to the first and second embodiments, for example, the CPU 901 of the computer 900 implements the functions of the offload server 1, 1A by executing the program loaded to the RAM 903. The HDD 904 stores data in the RAM 903. The CPU 901 reads the program related to the target processing from the recording medium 912, and executes the program. Additionally, the CPU 901 may read the program related to the target processing from another device via the communication network (NW 920).

### [Effects]

As described above, the offload server 1 according to the first embodiment includes the application code analysis unit 112 that analyzes a source code of an application, the data transfer designation unit 113 that, on the basis of a result of code analysis, performs designation such that data is transferred by batch before a start and after an end of GPU processing for a variable in which CPU processing and the GPU processing are not mutually referred to or updated and only a result of the GPU processing is returned to a CPU among variables that need transfer between the CPU and a GPU, the parallel processing designation unit 114 that specifies a loop sentence of the application, designates a parallel processing designation sentence in the GPU for each of the specified loop sentence, and performs compiling, the parallel processing pattern creation unit 115 that excludes a loop sentence which causes a compile error from an offloading target and creates a parallel processing pattern of designating whether to execute parallel processing for a loop sentence which does not cause a compile error, the performance measurement unit 116 that compiles the application of the parallel processing pattern, arranges the application in an accelerator verification apparatus, and executes processing of measuring processing achieved when offloading to an accelerator is performed, the evaluation value setting unit 116c that sets an evaluation value including a processing time and power consumption and having a higher value as a processing time is shorter and power consumption is lower on the basis of a processing time and power consumption required at a time of offloading measured by the performance measurement unit 116, and the execution file creation unit 117 that selects a parallel processing pattern having the highest evaluation value from among a plurality of the parallel processing patterns on the basis of a measurement result of the processing time and the power consumption, compiles the parallel processing pattern having the highest evaluation value, and creates an execution file.

In this way, the direction content (data copy or the like) to the GPU that exists in a distributed manner in a program is not individually transferred to the GPU, but variables that can be transferred by batch are collected, transferred, and directed by batch, so that transfer between the CPU and the GPU is reduced, and offloading is further speeded up. In addition, by not only a processing time at the time of automatic offloading but also power consumption being evaluated, performance can be improved and power consumption can be reduced (power reduction).

The offload server 1A according to the second embodiment includes the application code analysis unit 112 that analyzes a source code of an application, the PLD processing designation unit 213 that specifies a loop sentence of the application, creates a plurality of offload processing patterns in which pipeline processing or parallel processing in the PLD is designated by OpenCL for each of the specified loop sentence, and performs compiling, the arithmetic intensity calculation unit 214 that calculates arithmetic intensity of a loop sentence of the application, the PLD processing pattern creation unit 215 that performs narrowing down to a loop sentence having arithmetic intensity higher than a predetermined threshold as an offload possibility on the basis of the arithmetic intensity calculated by the arithmetic intensity calculation unit 214, and creates a PLD processing pattern, the performance measurement unit 116 that compiles the application of the created PLD processing pattern, arranges the application in the accelerator verification apparatus 14, and executes processing of measuring performance achieved when offloading to the PLD is performed, the evaluation value setting unit 116c that sets an evaluation value including a processing time and power consumption and having a higher value as a processing time is shorter and power consumption is lower on the basis of a processing time and power consumption required at a time of offloading measured by the performance measurement unit 116, and the execution file creation unit 117 that selects a PLD processing pattern having the highest evaluation value from among a plurality of the PLD processing patterns on the basis of a measurement result of the processing time and the power consumption, compiles the PLD processing pattern having the highest evaluation value, and creates an execution file.

Accordingly, the number of times of performance measurement can be reduced by a pattern to be actually measured for performance being obtained by narrowing down, then the pattern being arranged in the verification environment, compiling being performed, and performance being measured using an actual PLD (for example, FPGA) machine. As a result, in automatic offloading to the PLD, automatic offloading of a loop sentence of the application can be performed at high speed. In addition, by not only a processing time at the time of automatic offloading but also power consumption being evaluated, performance can be improved and power consumption can be reduced (power reduction).

The offload server 1, 1A that offloads application specific processing to at least one of a GPU, a many-core CPU, or a PLD, the offload server 1, 1A including the application code analysis unit 112 that analyzes a source code of an application, the data transfer designation unit 113 that, on the basis of a result of code analysis, performs designation such that data is transferred by batch before a start and after an end of GPU processing or many-core CPU processing for a variable in which CPU processing or the many-core CPU processing and the GPU processing are not mutually referred to or updated and only a result of the GPU processing or many-core CPU processing is returned to a central processing unit (CPU) among variables that need transfer between the CPU and the GPU or the many-core CPU, the parallel processing designation unit 114 that specifies a loop sentence for a GPU or a loop sentence for a many-core CPU of the application, designates a parallel processing designation sentence in the GPU for each of the specified loop sentence, and performs compiling, the PLD processing designation unit 213 that specifies a loop sentence for a PLD of the application, performs creation by a plurality of offload processing patterns in which pipeline processing or parallel processing in the PLD is designated by OpenCL for each of the specified loop sentence for a PLD, and performs compiling, the arithmetic intensity calculation unit 214 that calculates arithmetic intensity of a loop sentence for a PLD of the application, the PLD processing pattern creation unit 215 that performs narrowing down to a loop sentence having arithmetic intensity higher than a predetermined threshold as an offload possibility on the basis of the arithmetic intensity calculated by the arithmetic intensity calculation unit 214, and creates a PLD processing pattern, the parallel processing pattern creation unit 115 that excludes a loop sentence for a GPU or a loop sentence for a many-core CPU which causes a compile error from an offloading target and creates a parallel processing pattern of designating whether to execute parallel processing for a loop sentence for a GPU or a loop sentence for a many-core CPU which does not cause a compile error, the performance measurement unit 116 that compiles the application of the parallel processing pattern or the PLD processing pattern in a mixed environment of the GPU, the many-core CPU, and the PLD, arranges the application in an accelerator verification apparatus, and executes processing of measuring each piece of performance achieved when offloading to the GPU, the many-core CPU, and the PLD is performed, the evaluation value setting unit 116c that sets an evaluation value including a processing time and power consumption and having a higher value as a processing time is shorter and power consumption is lower on the basis of a processing time and power consumption required at a time of offloading of the GPU, the many-core CPU, and the PLD measured by the performance measurement unit 116, and the execution file creation unit 117 that selects one having the processing time and the power consumption that are the best from among the GPU, the many-core CPU, and the PLD on the basis of a measurement result of the processing time and the power consumption of the GPU, the many-core CPU, and the PLD, selects a parallel processing pattern or PLD processing pattern having the highest evaluation value from among a plurality of the parallel processing patterns or PLD processing patterns for the selected one, compiles the parallel processing pattern or PLD processing pattern having the highest evaluation value, and creates an execution file.

Accordingly, by three migration destinations of the GPU, the FPGA, and the many-core CPU being verified in a state where the GPU, the FPGA, and the many-core CPU are mixed as the migration destinations, and a migration destination excellent in performance enhancement and power reduction can be automatically selected and offloading can be performed.

### [Other Effects]

In the offload server 1 according to the first embodiment, the parallel processing designation unit 114 defines the number of loop sentences which do not cause a compile error as a gene length on the basis of a genetic algorithm, the parallel processing pattern creation unit 115 defines a case where GPU processing is performed as any one of 1 or 0 and defines a case where the GPU processing is not performed as the other one of 0 or 1, maps whether accelerator processing can be performed in a gene pattern, and prepares gene patterns of a designated number of individuals in which each value of a gene is randomly created to 1 or 0, the performance measurement unit 116 compiles an application code designating a parallel processing designation sentence in the GPU according to each of the individuals, arranges the application code in the accelerator verification apparatus 14, and executes performance measurement processing in the accelerator verification apparatus, and the execution file creation unit 117 performs performance measurement on each of the individuals, evaluates individuals having shorter processing times as having higher fitness, selects, as individuals having high performance, individuals having fitness higher than a predetermined value from among each of the individuals, performs crossover and mutation processing on the selected individuals, creates next generation individuals, and selects a parallel processing pattern having the highest performance as a solution after processing is ended a number of times corresponding to a designated number of generations.

Accordingly, parallelizable loop sentences are checked first and then performance verification trial is repeated on the parallelizable repeated sentence group in a verification environment using the GA, thus an appropriate region is searched for. Patterns, the speeds of which can be increased, can be efficiently searched for from an enormous number of possible parallel processing patterns by the parallel processing patterns, the speeds of which can be increased, being held and recombined in the form of a part of a gene after possibilities are narrowed down to the parallelizable loop sentences (for example, for sentences).

In the offload server 1A according to the second embodiment, the PLD processing pattern creation unit 215 measures the numbers of loops of loop sentences of an application, and performs narrowing down to loop sentences having arithmetic intensity higher than a predetermined threshold and the number of loops more than a predetermined number of times as offload possibilities.

Accordingly, by narrowing down to loop sentences having high arithmetic intensity and a large number of loops being performed, the loop sentences can be further narrowed down, and automatic offloading of the loop sentences of the application can be performed at a higher speed.

In the offload server 1A according to the second embodiment, the PLD processing pattern creation unit 215 creates OpenCL for offloading each of the loop sentences obtained by narrowing down to the PLD, precompiles the created OpenCL, calculates resource amounts used in PLD processing, and further narrows down offload possibilities on the basis of the calculated resource amounts.

Accordingly, by the arithmetic intensity, the numbers of loops, and the resource amounts of the loop sentences being analyzed, and loop sentences having high resource efficiency being obtained by narrowing down as offload possibilities, the loop sentences can be further narrowed down while the PLD (for example, FPGA) resources are prevented from being excessively consumed, and automatic offloading of the loop sentences of the application can be performed at a higher speed. Furthermore, since calculation of resource amounts used in PLD processing takes only minutes to reach a stage of an intermediate state of HDL or the like, the used resource amounts can be known in a short time even if compiling is not completed.

The present invention provides an offload program for causing a computer to function as the aforementioned offload server.

Accordingly, each function of the offload server 1 can be implemented using a general computer.

Furthermore, it is also possible to perform, as a manual operation, an entirety or a part of the processing that has been described as being automatically performed in the processing described above in each embodiment, or it is also possible to automatically perform, by a known method, an entirety or a part of the processing that has been described as being performed as a manual operation. In addition, processing procedures, control procedures, specific name, and information including various types of data and parameters illustrated in the specification and the drawings can be freely changed unless otherwise specified.

In addition, each component of each device that has been illustrated is functionally conceptual, and is not necessarily physically configured as illustrated. In other words, a specific form of distribution and integration of individual devices is not limited to the illustrated form, and all or part of the configuration can be functionally or physically distributed and integrated in any unit according to various loads, usage conditions, and the like.

Further, some or all of the component, functions, processing units, processing means, and the like described above may be implemented by hardware, for example, by designing them in an integrated circuit. Also, the respective components, functions, and the like may be implemented by software for interpreting and executing a program for causing a processor to implement the respective functions. Information such as a program, a table, and a file for implementing the respective functions can be held in a recording device such as a memory, a hard disk, or a solid state drive (SSD), or in a recording medium such as an integrated circuit (IC) card, a secure digital (SD) card, or an optical disc.

Furthermore, in the present embodiment, the genetic algorithm (GA) method is used in order to enable a solution to be found in a combination optimization problem during a limited optimization period, but any optimization method may be used. For example, local search (local search method), dynamic programming (dynamic programming method), or a combination thereof may be used.

Furthermore, in the present embodiment, the OpenACC compiler for C/C++ is used, but any compiler may be used as long as GPU processing can be offloaded. For example, Java lambda (registered trademark) GPU processing or IBM Java 9 SDK (registered trademark) may be used. Note that a parallel processing designation sentence depends on these development environments.

For example, Java (registered trademark) enables parallel processing description in a lambda format from Java 8. IBM (registered trademark) provides a JIT compiler that offloads parallel processing description in the lambda format to a GPU. Using these, in Java, similar offloading can be performed by tuning whether to set loop processing to the lambda format being performed by the GA.

Furthermore, in the present embodiment, a for sentence has been exemplified as a repeated sentence (loop sentence), but a while sentence and a do-while sentence other than a for sentence are also included. However, a for sentence that designates a loop continuation condition or the like is more suitable.

### REFERENCE SIGNS LIST

1, 1A Offload server
11, 21 Control unit
12 Input/output unit
13 Storage unit
14 Verification machine (accelerator verification apparatus)
111 Application code designation unit
112 Application code analysis unit
113 Data transfer designation unit
114 Parallel processing designation unit
114a, 213a Offload range extraction unit
114b, 213b Intermediate language file output unit
115 Parallel processing pattern creation unit
116 Performance measurement unit
116a Binary file arrangement unit
116b Power consumption measurement unit (performance measurement unit)
116c Evaluation value setting unit
117 Execution file creation unit
118 Production environment arrangement unit
119 Performance measurement test extraction execution unit
120 User provision unit
130 Application code
131 Test case DB
132 Intermediate language file
151 Various devices
152 Apparatus including CPU and GPU
153 Apparatus including CPU and FPGA
154 Apparatus including CPU
215 PLD processing pattern creation unit

1. An offload server configured to offload application specific processing to a graphics processing unit (GPU), the offload server comprising one or more processors configured to perform operations comprising:
analyzing a source code of an application;
on the basis of a result of code analysis, performing designation such that data is transferred by batch before a start and after an end of GPU processing for a variable in which central processing unit (CPU) processing and the GPU processing are not mutually referred to or updated and only a result of the GPU processing is returned to a CPU among variables that need transfer between the CPU and the GPU;
specifying a loop sentence of the application;
designating a parallel processing designation sentence in the GPU for each of the specified loop sentence;
performing compiling;
excluding a loop sentence which causes a compile error from an offloading target; and
creating a parallel processing pattern of designating whether to execute parallel processing for a loop sentence which does not cause a compile error;
compiling the application of the parallel processing pattern;
arranging the application in an accelerator verification apparatus; measuring performance achieved when offloading to the GPU is performed;
setting an evaluation value including a processing time and power consumption and having a higher value as a processing time is shorter and power consumption is lower on the basis of a processing time and power consumption required at a time of offloading measured by the measuring;
selecting a parallel processing pattern having a highest evaluation value from among a plurality of the parallel processing patterns on the basis of a measurement result of the processing time and the power consumption; and
compiling the parallel processing pattern having the highest evaluation value, and creating an execution file.

2. An offload server configured to offload application specific processing to a programmable logic device (PLD), the offload server comprising one or more processors configured to perform operations comprising:
analyzing a source code of an application;
specifying a loop sentence of the application;
performing creation by a plurality of offload processing patterns in which pipeline processing or parallel processing in the PLD is designated by OpenCL for each of the specified loop sentence;
performing compiling;
calculating arithmetic intensity of a loop sentence of the application;
performing narrowing down to a loop sentence having arithmetic intensity higher than a predetermined threshold as an offload possibility on the basis of the arithmetic intensity, and creates a PLD processing pattern;
compiling the application of the created PLD processing pattern;
arranging the application in an accelerator verification apparatus, and measuring performance achieved when offloading to the PLD is performed;
setting an evaluation value including a processing time and power consumption and having a higher value as a processing time is shorter and power consumption is lower on the basis of a processing time and power consumption required at a time of offloading measured by the measuring;
selecting a PLD processing pattern having a highest evaluation value from among a plurality of the PLD processing patterns on the basis of a measurement result of the processing time and the power consumption; and
compiling the PLD processing pattern having the highest evaluation value, and creating an execution file.

3. An offload server configured to offload application specific processing to at least one of a graphics processing unit (GPU), a many-core central processing unit (CPU), or a programmable logic device (PLD), the offload server comprising one or more processors configured to perform operations comprising:
analyzing a source code of an application;
on the basis of a result of code analysis, performing designation such that data is transferred by batch before a start and after an end of GPU processing or many-core CPU processing for a variable in which CPU processing or the many-core CPU processing and the GPU processing are not mutually referred to or updated and only a result of the GPU processing or many-core CPU processing is returned to a CPU among variables that need transfer between the CPU and the GPU or the many-core CPU;
specifying a loop sentence for a GPU or a loop sentence for a many-core CPU of the application, designating a parallel processing designation sentence in the GPU for each of the specified loop sentence;
performing compiling;
specifying a loop sentence for a PLD of the application;
performing creation by a plurality of offload processing patterns in which pipeline processing or parallel processing in the PLD is designated by OpenCL for each of the specified loop sentence for a PLD;
performing compiling;
calculating arithmetic intensity of a loop sentence for a PLD of the application;
performing narrowing down to a loop sentence having arithmetic intensity higher than a predetermined threshold as an offload possibility on the basis of the arithmetic intensity, and
creating a PLD processing pattern;
excluding a loop sentence for a GPU or a loop sentence for a many-core CPU which causes a compile error from an offloading target and creates a parallel processing pattern of designating whether to execute parallel processing for a loop sentence for a GPU or a loop sentence for a many-core CPU which does not cause a compile error;
compiling the application of the parallel processing pattern or the PLD processing pattern in a mixed environment of the GPU, the many-core CPU, and the PLD;
arranging the application in an accelerator verification apparatus;
measuring each piece of performance achieved when offloading to the GPU, the many-core CPU, and the PLD is performed;
setting an evaluation value including a processing time and power consumption and having a higher value as a processing time is shorter and power consumption is lower on the basis of a processing time and power consumption required at a time of offloading of the GPU, the many-core CPU, and the PLD measured by the measuring;
selecting one having the processing time and the power consumption that are best from among the GPU, the many-core CPU, and the PLD on the basis of a measurement result of the processing time and the power consumption of the GPU, the many-core CPU, and the PLD;
selecting a parallel processing pattern or PLD processing pattern having a highest evaluation value from among a plurality of the parallel processing patterns or PLD processing patterns for the selected one; and
compiling the parallel processing pattern or PLD processing pattern having the highest evaluation value, and creating an execution file.

4-7. (canceled)
